(19) United States
(12) Patent Application Publication
(10) Pub. No.: US 2024/0174553 A1
(43) Pub. Date: May 30, 2024

(54) WHITE GLASS-CERAMIC ARTICLES WITH OPACITY AND HIGH FRACTURE TOUGHNESS, AND METHODS OF MAKING THE SAME

(71) Applicant: CORNING INCORPORATED, CORNING, NY (US)

(72) Inventors: Carol Ann Click, Corning, NY (US); Qiang Fu, Painted Post, NY (US); Mathieu Gerard Jacques Hubert, Corning, NY (US); Charlene Marie Smith, Corning, NY (US); Alana Marie Whittier, Painted Post, NY (US)

(21) Appl. No.: 18/388,009

(22) Filed: Nov. 8, 2023

Related U.S. Application Data
(60) Provisional application No. 63/428,773, filed on Nov. 30, 2022.

(51) Int. Cl. C03C 10/00; C03C 4/02

(52) U.S. Cl. CPC C03C 10/0027; C03C 4/02; C03C 2204/04

(57) ABSTRACT

A glass-ceramic article, comprising (in mol %):
67-74% SiO₂;
2-6% Al₂O₃;
0.5-1.5% P₂O₅;
18-25% Li₂O;
0-1% Na₂O;
0-1% K₂O;
1-4% ZrO₂;
0-2% CaO; and
0.001-0.5% SnO₂. The glass-ceramic article is opaque, and further comprises a lithium disilicate crystalline phase, a β-spodumene solid solution crystalline phase, a Zr-based crystalline phase, and a lithium phosphate crystalline phase. The glass-ceramic article can further comprise a fracture toughness (K_{IC}) of from 1.0 to 3.0 MPa*m^{1/2}, as measured by the Chevron Notch Short Bar Method, and an opacity from 60 to 97%, as measured through the glass-ceramic article with a thickness of 0.5 mm.

### CROSS-REFERENCE TO RELATED APPLICATIONS

This application claims the benefit of U.S. Provisional Application Ser. No. 63/428,773, filed on Nov. 30, 2022, the content of which is relied upon and incorporated herein by reference in its entirety.

### FIELD OF THE DISCLOSURE

The disclosure generally relates to glass-ceramic articles and, more particularly, white glass-ceramic articles with opacity and high fracture toughness, including such glass-ceramic articles formed from precursor glass compositions, e.g., for use in various applications, including but not limited to mobile devices, cooktop plates and cooking utensils.

### BACKGROUND

Glass-ceramic materials have been used widely in various applications. Glass-ceramic cooktop plates and cooking utensils have found wide applications in modern kitchens. White, opaque glass-ceramics in the Li₂O—Al₂O₃—SiO₂ (“LAS”) composition field have also recently developed as an attractive component for mobile devices due to the combination of their attributes: white color, opacity, radio-wave transparency and suitability for chemical strengthening by ion exchange.

However, improvement of the mechanical properties of glass-ceramic materials, particularly damage resistance and fracture toughness, remains an ongoing challenge within the materials community. In the context of glass-ceramics, such as those employed in mobile device applications, these mechanical property developments have centered around glass-ceramic compositions that exhibit transparency and/or translucency suitable for cover display components.

Accordingly, there remains a need for glass-ceramic articles and, more particularly, white glass-ceramic articles with opacity and high fracture toughness and methods of making these articles.

### SUMMARY

According to an aspect of the disclosure, a glass-ceramic article is provided that includes (in mol %):
68-70% SiO₂;
3.5-4.5% Al₂O₃;
0.5-1.5% P₂O₅;
20-24% Li₂O;
0-0.5% Na₂O;
0-0.5% K₂O;
2.5-3.1% ZrO₂;
0.5-1.0% CaO;
0-0.2% Fe₂O₃;
0-0.2% HfO₂; and
0.001-0.2% SnO₂. The glass-ceramic article is opaque, and further comprises a lithium disilicate crystalline phase, a β-spodumene solid solution crystalline phase, a Zr-based crystalline phase, and a lithium phosphate crystalline phase.

According to another aspect of the disclosure, a glass-ceramic article is provided that includes (in mol %):
70-72% SiO₂;
3.5-4.5% Al₂O₃;
0.5-1.5% P₂O₅;
20-24% Li₂O;
0-0.5% Na₂O;
0-0.5% K₂O;
1.7-2.3% ZrO₂;
0-0.5% CaO;
0-0.2% Fe₂O₃;
0-0.2% HfO₂; and
0.001-0.2% SnO₂. The glass-ceramic article is opaque, and comprises a β-spodumene solid solution crystalline phase, a lithium disilicate crystalline phase, and one or more ZrO₂-containing crystalline phases. Further, the glass-ceramic article is derived from a glass precursor having a β-OH content from 0.1 to 0.5/mm.

According to a further aspect of the disclosure, a glass-ceramic article is provided that includes (in mol %):
67-74% SiO₂;
2-6% Al₂O₃;
0.5-1.5% P₂O₅:
18-25% Li₂O;
0-1% Na₂O;
0-1% K₂O;
1-4% ZrO₂;
0-2% CaO; and
0.001-0.5% SnO₂. The glass-ceramic article is opaque, and further comprises a lithium disilicate crystalline phase, a β-spodumene solid solution crystalline phase, a Zr-based crystalline phase, and a lithium phosphate crystalline phase. The glass-ceramic article can further comprise a fracture toughness (K_{IC}) of from 1.0 to 3.0 MPa*m^{1/2}, as measured by the Chevron Notch Short Bar Method, and an opacity from about 60 to 97%, as measured through the article with a thickness of about 0.5 mm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 schematically depicts a glass-ceramic article having a compressive stress region, according to one or more embodiments of the disclosure;

FIG. 2A is a plan view of a mobile device incorporating any of the glass-ceramic articles, according to one or more embodiments of the disclosure;

FIG. 2B is a perspective view of the mobile device of FIG. 2A;

FIG. 3 is an x-ray diffraction (XRD) spectrum for a glass-ceramic article, according to one or more embodiments of the disclosure;

FIG. 4A is a box plot of Knoop hardness levels for three groups of glass-ceramic articles having different compositions and subjected to differing ceramming conditions, according to embodiments of the disclosure;

FIGS. 4B and 4C are microprobe profiles of Na₂O and K₂O concentration, respectively, as a function of depth within the glass-ceramic articles of FIG. 4A, as subjected to an ion exchange treatment, according to embodiments of the disclosure;

FIGS. 5A and 5B are scanning electron microscope (SEM) images of a glass-ceramic article, according to one or more embodiments of the disclosure;

FIGS. 5C and 5D are SEM images of a glass-ceramic article of FIGS. 5A and 5B, along with a glass-ceramic article having a different composition and subjected to a different ceramming condition, according to embodiments of the disclosure;

FIG. 6A is a plot of transmittance vs. wavenumber in the near infrared (NIR) spectrum for glass compositions with different β-OH content, which can be cerammed to obtain glass-ceramic articles according to embodiments of the disclosure;

FIG. 6B is a differential scanning calorimetry (DSC) plot for two of the glass compositions of FIG. 6A, according to embodiments of the disclosure;

FIG. 7A is a plot of opacity vs. the amount of zirconia in three glass-ceramic articles, according to embodiments of the disclosure;

FIG. 7B is a plot of minor phase amounts in two glass-ceramic articles as a function of time during the growth phase of a ceram cycle at 875° C., according to embodiments of the disclosure;

FIG. 8A is XRD spectra for glass-ceramic articles, according to embodiments of the disclosure;

FIG. 8B is the XRD spectra from FIG. 8A, enlarged for two-theta from 25° to 35°; and

FIG. 9 is a plot of the amount of zirconia as a function of nucleation temperature for two glass-ceramic articles, according to embodiments of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Further, when one or both endpoints of a range, or any particular value, is expressed using the term “about”, each such endpoint or value modified by “about” can be varied within +5% of the stated endpoint or value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow: plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As described herein, x-ray diffraction (XRD) spectra are measured with a D4 Endeavor X-ray Diffraction system equipped with Cu radiation and a LynxEye XE-T detector manufactured by Bruker Corporation (Billerica, MA), and evaluated using Rietveld analysis techniques as understood by those skilled in the field of the disclosure to develop and characterize the phase assemblages present.

As also described herein, scanning electron microscopy (SEM) images were generated from a Zeiss GeminiSEM 500 Scanning Electron Microscope, with the specific parameters used to generate the images identified in the figures in this disclosure.

As described herein, differential scanning calorimetry (DSC) is conducted according to a technique understood by those of ordinary skill in the field of the disclosure. Unless otherwise noted, DSC was conducted on samples of this disclosure and analyzed in a Netzsch 404 F1 high-resolution DSC apparatus in an argon atmosphere, as heated at 10° C./min to 1000° C. within a platinum pan.

As used herein, the “Knoop hardness” of the glass-ceramic articles of the disclosure is measured with a Mitutoyo HM114-320243 with a 200 gram load, and reported in units of kgf/mm².

The “elastic modulus” (also referred to as “Young's modulus”) of the glass-ceramic article, as described herein, is provided in units of Gigapascals (GPa) and is measured with resonant ultrasonic spectroscopy in accordance with ASTM E2001-13. Shear modulus (also provided in units of GPa) and Poisson's ratio values of the glass-ceramic articles of the disclosure are also measured with resonant ultrasonic spectroscopy with ASTM E2001-13.

The term “fracture toughness,” as used herein, refers to the K_{IC} value, and is measured using the Chevron Notch Short Bar test method described in ASTM E 1304-97, the contents of which are incorporated herein by reference in their entirety. Unless otherwise indicated, the fracture toughness value is measured on an article that has not been strengthened, such as by ion-exchange strengthening treatments.

As used herein, “a compressive stress region” is a region in embodiments of the glass-ceramic articles of the disclosure in which alkali metal ions (e.g., K⁺ ions) have been exchanged through an ion-exchange strengthening process for ion-exchangeable alkali metal ions (Na⁺ ions) present in the glass-ceramic after melting and before or after being subjected to a ceramming process. Further, the terms “depth of compression” and “DOC” refer to the position in the glass-ceramic article where compressive stress transitions to tensile stress. In addition, the terms “depth of layer” and “DOL” refer to a depth within the glass-ceramic article that defines the depth to which alkali metal ions have been exchanged after being subjected to an ion-exchange strengthening process. Unless otherwise indicated, DOL as utilized herein refers to the depth of potassium ion exchange in the glass-ceramic article.

As used herein, the term “transmittance” or “average transmittance” is defined as the percentage of incident optical power within a given wavelength range transmitted through a material (e.g., the cover article, the substrate, the outer layered film, or portions thereof). The term “reflectance” is similarly defined as the percentage of incident optical power within a given wavelength range that is reflected from a material (e.g., the cover article, the substrate, or the outer layered film, or portions thereof). Transmittance and reflectance are measured using a specific linewidth. As used herein, an “average transmittance” refers to the average amount of incident optical power transmitted through a material over a defined wavelength regime, e.g., “an optical wavelength regime”, as also defined herein from 400 nm to 800 nm. Unless otherwise noted, a suitable interval for average transmittance measurements is 5 nm. As used herein, an “average reflectance” refers to the average amount of incident optical power reflected by the material.

The term “opaque,” when used to describe a glass-ceramic article formed of the precursor glass compositions described herein, means that the glass-ceramic article has an average transmittance of less than 20% when measured at normal incidence for light in a wavelength range from 400 nm to 800 nm (inclusive of endpoints) at an article thickness of 0.8 mm.

As used herein, the “color” or “reflected color” associated with the glass-ceramic articles of the disclosure is measured as a reflected color given in the CIELAB color space (CIE L*, a*, and b* coordinate system) with a CIE F02-10 illuminant under SCI UVC conditions with a 25 mm aperture, as understood by those skilled in the field of this disclosure. Further, unless otherwise noted, a white background reference (“white tile”) or a black background reference (“black trap”) was employed for all of the measurements reported in the disclosure. In addition, all opacity measurements reported in the disclosure were obtained with this same system and parameters.

The term “failure height,” as used herein, refers to the lowest height from which a device including a glass-ceramic article can be dropped and the glass-based article fails (i.e., cracks). The Drop Test Method is used to determine the failure height on a device. The Drop Test Method involves performing face-drop testing on a puck with a glass-based article attached thereto. The glass-ceramic article is attached to the puck (e.g., with double-sided tape or with an epoxy) during the drop test described herein below. The glass-ceramic article to be tested has a thickness similar or equal to the thickness that will be used in a given hand-held consumer electronic device, such as 0.5 mm or 0.6 mm. A puck refers to a structure meant to mimic the size, shape, and weight distribution of a given device, such as a cell phone. Hereinafter, the term “puck,” refers to a structure that has a weight of 126.0 grams, a length of 133.1 mm, a width of 68.2 mm, and a height of 9.4 mm. In embodiments, the puck has the dimensions and weight similar to a handheld electronic device.

An exemplary device-drop machine may be used to conduct the Drop Test Method. The device-drop machine includes a chuck having chuck jaws. The puck is staged in the chuck jaws with the glass-ceramic article attached thereto and facing downward. The chuck is ready to fall from, for example, an electro-magnetic chuck lifter. Next, the chuck is released and during its fall, the chuck jaws are triggered to open by, for example, a proximity sensor. As the chuck jaws open, the puck is released. At this point, the falling puck strikes a drop surface. The drop surface may be sandpaper, such as 180 grit sandpaper, 80 grit sandpaper, 60 grit sandpaper, or 30 grit sandpaper, as positioned on a steel plate. If the glass-based article attached to the puck survives the fall (i.e., does not crack), the chuck is set at an increased height and the test is repeated. The failure height is then the lowest height from which the puck including the glass-ceramic article is dropped and the glass-ceramic article fails. A single glass-ceramic article is tested at multiple heights, such as at 20 cm, 30 cm, 40 cm, 50 cm, 60 cm, 70 cm, 80 cm, 90 cm, 100 cm, 110 cm, 120 cm, 130 cm, 140 cm, 150 cm, 160 cm, 170 cm, and increments of 10 centimeters until the glass-ceramic article fails by fracturing. The sandpaper is replaced upon failure of the glass-ceramic article.

The term “retained strength” or “Retained Strength Test Method”, as used herein, refers to the strength of a glass-ceramic article after damage introduction by an impact force when the article is bent to impart tensile tress. Damage is introduced according to the method described in U.S. Patent Publication No. 2019/0072469 A1, which is incorporated herein by reference. For example, an apparatus for impact testing a glass-ceramic article can include a pendulum including a bob attached to a pivot. The term “bob” on a pendulum, as used herein, is a weight suspended from and connected to a pivot by an arm. Thus, the bob is connected to the pivot by an arm. The bob includes a base for receiving a glass-ceramic article, and the glass-ceramic article is affixed to the base. The apparatus further includes an impacting object positioned such that when the bob is released from a position at an angle greater than zero from the equilibrium position, the surface of the bob contacts the impacting object.

According to the Retained Strength Test Method, the impacting object includes an abrasive sheet having an abrasive surface to be placed in contact with the outer surface of the glass-ceramic article. The abrasive sheet may comprise sandpaper, which may have a grit size in the range of 30 grit to 1000 grit, or 100 grit to 300 grit, for example 80 grit, 120 grit, 180 grit, and 1000 grit sandpaper). Unless otherwise indicated, 180 grit, 80 grit, or 30 grit sandpaper was used herein to measure retained strength. Further, for purposes of this disclosure, the impacting object was in the form of a 6 mm diameter disk of the sandpaper affixed to the apparatus. A glass-ceramic article having a thickness of approximately 600.0 μm was affixed to the bob. For each impact, a fresh sandpaper disk was used. Damage on the glass-ceramic article was done at approximately 500.0 N impact force by pulling the swing of the arm of the apparatus to approximately a 90° angle. Approximately 10 samples of each glass-ceramic article were impacted.

Twenty-four hours after the damage introduction, the glass-ceramic articles were fractured in four-point bending (4PB) according to the Retained Strength Test Method. The damaged glass-ceramic article was placed on support rods (support span) with the damaged site on the bottom (i.e., on the tension side) and between the load roads (loading span). For purposes of this disclosure, the loading span was 18 mm and the support span was 36 mm. The radius of curvature of load and support rods was 3.2 mm. Loading was done at a constant displacement rate of 5 mm/min using a screw-driven testing machine (Instron®, Norwood, Massachusetts, USA) until failure of the glass. The 4PB tests were performed at a temperature of 22° C.±2° C. and at a relative humidity (RH) of 50%+5%. The applied fracture stress (or the applied stress to failure) σₐₚₚ in four-point bending (4PB) was calculated from Equation (1) as follows:

$${σ}_{app} = \frac{1}{( 1 - {v}^{2} )} \frac{3 P ( L - a )}{2 {bh}^{2}} \qquad ( 1 )$$

where, P is the maximum load to failure, L (=36 mm) is the distance between support rods (support span), a (=18 mm) is the distance between the loading rods (loading span), b is the width of the glass plate, h is the thickness of the glass plate and v is the Poisson's Ratio of the glass composition. The term (1/(1−v²)) in Equation (1) considers the stiffening effect of a plate. In four-point bending, stress is constant under the loading span and thus, the damaged site is under mode I uniaxial tensile stress loading. The stressing rate of the 4-point bend testing for the specimens was estimated to be between 15 to 17 MPa per sec. The retained strength of the glass-ceramic composition is the highest applied fracture stress (e.g., 300 MPa, 350 MPa, 400 MPa, 425 MPa, etc.) at which failure does not occur.

The term “precursor glass composition,” as used herein, refers to a glass composition which, upon heat treatment, may form a glass-ceramic article.

The term “glass-ceramic article,” as used herein, refers to an article formed from heat treating a glass article formed from a precursor glass composition to induce nucleation of the crystalline phase, such that the glass-ceramic article includes the crystalline phase and a residual glass phase.

The term “crystalline phase size” as used herein, refers to the size of the largest dimension of a crystalline phase as determined by review and evaluation of SEM micrographs.

Generally, this disclosure is directed to glass-ceramic articles with opacity and high fracture toughness and methods of making these articles. The precursor glass compositions (i.e., the precursor glasses) and glass-ceramic articles described herein may be generically described as lithium-containing aluminosilicate glasses or glass-ceramics and comprise SiO₂, Al₂O₃, and Li₂O. In addition to SiO₂, Al₂O₃, and Li₂O, the glasses and glass-ceramics embodied herein may further contain alkali oxides, such as Na₂O, K₂O, Rb₂O, or Cs₂O, as well as P₂O₅ and ZrO₂, and a number of other components as described below. In one or more embodiments, the major crystalline phases include lithium silicate, β-spodumene solid solution, lithium phosphate and Zr-based crystalline phases. Other crystalline phases that may be present include β-quartz solid solution, cristobalite, and rutile, depending on the compositions of the precursor glass.

More specifically, the disclosure relates to a group of Li₂O—Al₂O₃—SiO₂ glass-ceramic articles having lithium disilicate and β-spodumene solid solution as the primary crystal phases, and ZrO₂, β-quartz, cristobalite, lithium phosphate, sogdianite, and/or zircon as minor phases. In general, the compositions can contain, as represented in molar percentage, 55-75% SiO₂, 0.2-10% Al₂O₃, 0-5% B₂O₃, 15-30% Li₂O, 0-2% Na₂O, 0-2% K₂O, 0-2% CaO, 0-2% MgO, 0-2% ZnO, 0.2-3.0% P₂O₅, 0.1-10% ZrO₂, 0-4% TiO2, 0.001-1.0% SnO₂, and 0-2% Y₂O₃. Both crystalline phases, including β-spodumene solid solution and lithium disilicate, and the residual glass phases in the glass-ceramic articles of the disclosure can be ion-exchanged in a NaNO₃ (and or KNO₃, or AgNO₃) bath to form a compressive layer on a surface (i.e., “surface compressive stress”) that leads to improved mechanical properties. In some embodiments, the glass-ceramic articles of the disclosure constitute a white glass-ceramic family in the Li₂O—Al₂O₃—SiO₂ (LAS) system containing lithium silicates and β-spodumene solid solution as major crystalline phases, and lithium phosphate, zirconia and zirconia-silicate as key minor phases.

As noted earlier, the glass-ceramic articles of the disclosure can exhibit opacity and high fracture toughness. With regard to opacity, embodiments of the glass-ceramic articles can exhibit opacity from 60 to 97%, as measured through an article with a thickness of about 0.5 mm. With regard to fracture toughness, embodiments of the glass-ceramic articles can exhibit a fracture toughness (K_{IC}) of from 1.0 to 3.0 MPa*m^{1/2}, as measured by the Chevron Notch Short Bar Method. Embodiments of the glass-ceramic articles of the disclosure can also be formulated and/or processed with a glass precursor having a β-OH content from 0.15/mm to 0.4/mm (of the precursor article) for various benefits, e.g., to develop and/or enhance the mechanical and/or optical properties of the resulting glass-ceramic article.

With regard to the precursor glass compositions of the disclosure, SiO₂ is the primary glass former and can function to stabilize the network structure of precursor glasses and glass-ceramic articles. In embodiments, the precursor glass or glass-ceramic composition comprises from 55 to 80 mol % SiO₂. In embodiments, the precursor glass or glass-ceramic composition comprises from 60 to 80 mol % SiO₂. In embodiments, the precursor glass or glass-ceramic composition comprises from 65 to 75 mol % SiO₂. In embodiments, the precursor glass or glass-ceramic composition comprises from 67 to 74 mol % SiO₂. In some embodiments, the glass or glass-ceramic composition can comprise from 55 to 80 mol %, 55 to 77 mol %, 55 to 75 mol %, 55 to 73 mol %, 60 to 80 mol %, 60 to 77 mol %, 60 to 75 mol %, 60 to 73 mol %, 60 to 72 mol %, 64 to 80 mol %, 64 to 77 mol %, 64 to 75 mol %, 64 to 74 mol %, 64 to 73 mol %, 64 to 72 mol %, 67 to 80 mol %, 67 to 77 mol %, 67 to 75 mol %, 67 to 74 mol %, 67 to 73 mol %, 67 to 72 mol %, 68 to 70 mol %, 70 to 80 mol %, 70 to 77 mol %, 70 to 75 mol %, 70 to 72 mol %, 73 to 80 mol %, 73 to 77 mol %, 73 to 75 mol %, 75 to 80 mol %, 75 to 77 mol %, or 77 to 80 mol % SiO₂, or any and all sub-ranges formed from any of these endpoints.

Like SiO₂, Al₂O₃ may also provide stabilization to the network and also provides improved mechanical properties and chemical durability. If the amount of Al₂O₃ is too high, however, the fraction of lithium disilicate crystals may be decreased, possibly to the extent that an interlocking structure cannot be formed. The amount of Al₂O₃ can be tailored to control viscosity. Further, if the amount of Al₂O₃ is too high, the viscosity of the melt is also generally increased. In embodiments, the glass or glass-ceramic composition can comprise from 1 to 8 mol % Al₂O₃. In embodiments, the glass or glass-ceramic composition can comprise from 1.5 to 7 mol % Al₂O₃. In embodiments, the glass or glass-ceramic composition can comprise from 1.0 to 6 mol % Al₂O₃. In embodiments, the glass or glass-ceramic composition can comprise from 1.0 to <7 mol % A1203. In some embodiments, the glass or glass-ceramic composition can comprise from 1 to 6 mol %, 2 to 6 mol %, 3 to 6 mol %, 3.5 to 6 mol %, 3.5 to 5.5 mol %, 3.5 to 5 mol %, 3.5 to 4.5 mol % Al₂O₃, or any and all sub-ranges formed from any of these endpoints.

In the precursor glass and glass-ceramic articles described herein, Li₂O aids in forming lithium disilicate crystalline phases. To obtain lithium disilicate as a predominant crystal phase, it is desirable to have at least 15 mol % Li₂O in the composition. However, if the concentration of Li₂O is too high—greater than 30 mol %—the composition becomes very fluid and the delivery viscosity is low enough that a sheet cannot be formed. In some embodied compositions, the glass or glass-ceramic can comprise from 15 mol % to 30 mol % Li₂O. In other embodiments, the glass or glass-ceramic can comprise from 18 mol % to 25 mol % Li₂O. In other embodiments, the glass or glass-ceramic can comprise from 20 mol % to 24 mol % Li₂O. In some embodiments, the glass or glass-ceramic composition can comprise from 15 to 30 mol %, 15 to 28 mol %, 15 to 26 mol %, 15 to 24 mol %, 15 to 22 mol %, 18 to 30 mol %, 18 to 28 mol %, 18 to 26 mol %, 18 to 25 mol %, 18 to 24 mol %, 18 to 22 mol %, 19 to 30 mol %, 19 to 28 mol %, 19 to 26 mol %, 19 to 24 mol %, 19 to 22 mol %, 20 to 30 mol %, 20 to 28 mol %, 20 to 26 mol %, 20 to 24 mol %, 20 to 22 mol % Li₂O, or any and all sub-ranges formed from any of these endpoints.

As noted above, Li₂O is generally useful for forming the embodied glass-ceramic articles, but the other alkali oxides (e.g., K₂O and Na₂O) tend to decrease glass-ceramic formation and form an aluminosilicate residual glass in the glass-ceramic rather than a ceramic phase. Consequently, the compositions described herein have generally low amounts of non-lithium alkali oxides. In some embodiments, the glass or glass-ceramic composition can comprise from 0 to 4 mol % R₂O, wherein R is one or more of the alkali cations Na and K. In some embodiments, the glass or glass-ceramic composition can comprise from 0 to 3 mol % R₂O, wherein R is one or more of the alkali cations Na and K. In some embodiments, the glass or glass-ceramic composition can comprise from 0 to 3 mol %, 0 to 2 mol %, 0 to 1 mol %, 0 to 0.5 mol %, >0 to 3 mol %, >0 to 2 mol %, >0 to 1 mol %, >0 to 0.75 mol %, >0 to 0.5 mol %, 1 to 3 mol %, 1 to 2 mol %, 1.5 to 3 mol %, and 1.5 to 2 mol % Na₂O, K₂O, or combinations thereof. It should be understood that the R₂O concentration may be within a sub-range formed from any and all of the foregoing endpoints.

Optionally, the glasses and glass-ceramic articles herein can comprise boron, e.g., from 0 to 5 mol %, or from 0 to 2 mol % B₂O₃. In embodiments, the precursor glass composition or glass-ceramic articles can comprise from 0 to 5 mol %, 0 to 4 mol %, 0 to 3 mol %, 0 to 2 mol %, 0 to 1 mol %, >0 to 5 mol %, >0 to 4 mol %, >0 to 3 mol %, >0 to 2 mol %, >0 to 1 mol %, 1 to 5 mol %, 1 to 4 mol %, 1 to 2 mol %, 2 to 5 mol %, 2 to 4 mol %, 3 to 5 mol %, 3 to 4 mol %, 4 to 5 mol %, or any and all sub-ranges formed from any of these endpoints. In some embodiments, the precursor glasses and glass-ceramic articles are substantially free of B₂O₃. As utilized herein, the term “substantially free” indicates that a component was not purposefully added to the material but may be present as impurities, such as in amounts up to 0.01 mol %.

The precursor glass compositions and glass-ceramic articles can include P₂O₅. P₂O₅ can function as a nucleating agent to produce bulk nucleation of the crystalline phase(s) from the glass and glass-ceramic compositions. If the concentration of P₂O₅ is too low, the precursor glass does crystallize, but only at higher temperatures (due to a lower viscosity): however, if the concentration of P₂O₅ is too high, devitrification upon cooling during precursor glass forming can be difficult to control. Embodiments can comprise from >0 to 3 mol % P₂O₅. Other embodiments can comprise >0 to 2.5 mol % P₂O₅, >0 to 2 mol % P₂O₅, or even >0 to 1.5 mol % P₂O₅. Embodied compositions can comprise from 0 to 3 mol %, 0 to 2.5 mol %, 0 to 2 mol %, 0 to 1.5 mol %, 0 to 1 mol %, >0 to 3 mol %, >0 to 2.5 mol %, >0 to 2 mol %, >0 to 1.5 mol %, >0 to 1 mol %, 0.2 to 3 mol %, 0.2 to 2.5 mol %, 0.2 to 2 mol %, 0.2 to 1.5 mol %, 0.2 to 1 mol %, 0.3 to 3 mol %, 0.3 to 2.5 mol %, 0.3 to 2 mol %, 0.3 to 1.5 mol %, 0.3 to 1 mol %, 0.4 to 3 mol %, 0.4 to 2.5 mol %, 0.4 to 2 mol %, 0.4 to 1.5 mol %, 0.4 to 1 mol %, 0.5 to 3 mol %, 0.5 to 2.5 mol %, 0.5 to 2 mol %, 0.5 to 1.5 mol %, 0.5 to 1 mol %, 0.7 to 3 mol %, 0.7 to 2.5 mol %, 0.7 to 2 mol %, 0.7 to 1.5 mol %, 0.7 to 1 mol %, 1 to 3 mol %, 1 to 2.5 mol %, 1 to 2 mol %, 1 to 1.5 mol %, 1.5 to 3 mol %, 1.5 to 2.5 mol %, 1.5 to 2 mol %, 2 to 3 mol %, 2 to 2.5 mol %, 2.5 to 3 mol % P₂O₅, or any and all sub-ranges formed from any of these endpoints.

In the precursor glass compositions and glass-ceramic articles described herein, additions of ZrO₂ can improve the stability of Li₂O—Al₂O₃—SiO₂—P₂O₅ glass by significantly reducing glass devitrification during forming and decreasing the liquidus temperature. Additions of ZrO₂ can form a primary liquidus phase at a high temperature, which significantly lowers the liquidus viscosity. In some embodiments, the glass or glass-ceramic composition can comprise from 1 to 6 mol % ZrO₂. In some embodiments, the glass or glass-ceramic composition can comprise from 2 to 5 mol % or 1 to 4 mol % ZrO₂. In some embodiments, the glass or glass-ceramic composition can comprise from 1 to 6 mol %, 1 to 5 mol %, 1 to 4 mol %, 1.5 to 6 mol %, 1.5 to 4 mol %, 1.7 to 4 mol %, 1.7 to 3 mol %, 1.7 to 2.5 mol %, 1.7 to 2.3 mol %, 2 to 6 mol %, 2 to 4 mol %, 2.5 to 6 mol %, 2.5 to 4 mol %, 2.5 to 3.5 mol %, 2.5 to 3.1 mol %, 3 to 6 mol %, 3 to 4 mol %, 3.5 to 6 mol %, 3.5 to 5 mol % ZrO₂, or any sub-ranges formed from these endpoints.

In one or more embodiments, the precursor glass compositions and glass-ceramic articles can comprise from 0 to 0.5 mol % SnO₂, or another fining agent. In embodiments, the glass or glass-ceramic composition can comprise from 0 to 0.5 mol %, 0 to 0.4 mol %, 0 to 0.3 mol %, 0 to 0.2 mol %, 0 to 0.1 mol %, 0.001 to 0.5 mol %, 0.001 to 0.4 mol %, 0.001 to 0.3 mol %, 0.001 to 0.2 mol %, 0.01 to 0.5 mol %, 0.01 to 0.4 mol %, 0.01 to 0.3 mol %, 0.01 to 0.2 mol %, 0.05 to 0.5 mol %, 0.05 to 0.4 mol %, 0.05 to 0.3 mol %, 0.05 to 0.2 mol %, 0.05 to 0.1 mol %, 0.1 to 0.5 mol %, 0.1 to 0.4 mol %, 0.1 to 0.3 mol %, 0.1 to 0.2 mol %, 0.2 to 0.5 mol %, 0.2 to 0.4 mol %, 0.2 to 0.3 mol %, 0.3 to 0.5 mol %, 0.3 mol % to 0.4 mol %, or 0.4 to 0.5 mol % SnO₂, or any and all sub-ranges formed from any of these endpoints.

CaO can enter into the residual glass phase of the glass-ceramic articles of the disclosure and/or participate in crystallization of other minor phases in the glass-ceramic articles. In embodiments, the precursor glass and glass-ceramic articles can comprise from 0 to 4 mol %, from 0 to 3 mol %, or from 0 to 2 mol % CaO. In some embodiments, the precursor glass or glass-ceramic articles can comprise from 0 to 2 mol %, 0 to 1.75 mol %, 0 to 1.5 mol %, 0 to 1 mol %, 0 to 0.5 mol %, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % CaO, or any sub-ranges formed from these endpoints.

In one or more embodiments, the precursor glass compositions and glass-ceramic articles of the disclosure can comprise from 0 to 0.5 mol % Fe₂O₃. In embodiments, the precursor glass composition or glass-ceramic article can comprise from 0 to 0.5 mol %, 0 to 0.4 mol %, 0 to 0.3 mol %, 0 to 0.2 mol %, 0 to 0.1 mol %, 0.05 to 0.5 mol %, 0.05 to 0.4 mol %, 0.05 to 0.3 mol %, 0.05 to 0.2 mol %, 0.05 to 0.1 mol %, 0.1 to 0.5 mol %, 0.1 to 0.4 mol %, 0.1 to 0.3 mol %, 0.1 to 0.2 mol %, 0.2 to 0.5 mol %, 0.2 to 0.4 mol %, 0.2 to 0.3 mol %, 0.3 to 0.5 mol %, 0.3 mol % to 0.4 mol %, 0.4 to 0.5 mol % Fe₂O₃, or any sub-ranges formed from these endpoints.

In one or more embodiments, the precursor glass compositions and glass-ceramic articles of the disclosure can comprise from 0 to 0.5 mol % HfO₂. In embodiments, the precursor glass composition or glass-ceramic article can comprise from 0 to 0.5 mol %, 0 to 0.4 mol %, 0 to 0.3 mol %, 0 to 0.2 mol %, 0 to 0.1 mol %, 0.05 to 0.5 mol %, 0.05 to 0.4 mol %, 0.05 to 0.3 mol %, 0.05 to 0.2 mol %, 0.05 to 0.1 mol %, 0.1 to 0.5 mol %, 0.1 to 0.4 mol %, 0.1 to 0.3 mol %, 0.1 to 0.2 mol %, 0.2 to 0.5 mol %, 0.2 to 0.4 mol %, 0.2 to 0.3 mol %, 0.3 to 0.5 mol %, 0.3 mol % to 0.4 mol %, or 0.4 to 0.5 mol % HfO₂, or any and all sub-ranges formed from any of these endpoints.

Table 1 lists three composition spaces (Exs. A-C) for the precursor glass compositions and glass-ceramic articles, according to one or more embodiments shown and described herein.

TABLE 1
Composition space of glass-articles & glass precursors

| mol % oxide | Ex. A | Ex. B | Ex. C |
|---|---|---|---|
| SiO₂ | 67-74% | 68-70% | 70-72% |
| Al₂O₃ | 2-6% | 3.5-4.5% | 3.5-4.5% |
| P₂O₅ | 0.5-1.5% | 0.5-1.5% | 0.5-1.5% |
| Li₂O | 18-25% | 20-24% | 20-24% |
| Na₂O | 0-1% | 0-0.5% | 0-0.5% |
| K₂O | 0-1% | 0-0.5% | 0-0.5% |
| ZrO₂ | 1-4% | 2.5-3.1% | 1.7-2.3% |
| CaO | 0-2% | 0.5-1.0% | 0-0.5% |
| Fe₂O₃ | ** | 0-0.2% | 0-0.2% |
| HfO₂ | ** | 0-0.2% | 0-0.2% |
| SnO₂ | 0.001-0.5% | 0.001-0.2% | 0.001-0.2% |

Table 2 includes two exemplary compositions (Exs. D1 and D2) of glass precursor compositions and/or glass-ceramic articles, according to one or more embodiments shown and described herein.

TABLE 2
Exemplary glass-article & glass precursor compositions

| mol % oxide | Ex. D1 | Ex. D2 |
|---|---|---|
| SiO₂ | 70.8% | 69% |
| Al₂O₃ | 4.24% | 4.03% |
| P₂O₅ | 0.84% | 1.01% |
| Li₂O | 21.7% | 22.3% |
| Na₂O | 0.06% | 0.06% |
| K₂O | 0.07% | 0.07% |
| ZrO₂ | 2.01% | 2.78% |
| CaO | 0.03% | 0.71% |
| Fe₂O₃ | 0.02% | 0.02% |
| HfO₂ | 0.02% | 0.03% |
| SnO₂ | 0.15% | 0.01% |

As noted earlier, glass-ceramic articles derived from the glass precursor compositions of the disclosure can contain lithium disilicate. Lithium disilicate, Li₂Si₂O₅, is an orthorhombic crystal based on corrugated sheets of Si₂O₅ tetrahedral arrays. The crystals are typically tabular or lath-like in shape, with pronounced cleavage planes. The glass-ceramic articles of the disclosure based on lithium disilicate offer highly desirable mechanical properties, including high body strength and fracture toughness, due to their microstructures of randomly-oriented interlocking crystals. Glass-ceramic articles of the disclosure can exhibit fracture toughness values of 1.0 to 3.0 MPa·m^{1/2} in this composition system.

Further strengthening of the lithium disilicate glass-ceramic articles of the disclosure can be achieved by ion exchanging smaller alkali metal ions in the articles (e.g., Na⁺ ions) with larger ones present in a molten salt bath (e.g., K⁺ ions). The resulting alkali metal ion profiles (e.g., K⁺ ions) and accompanying compressive stress profiles can be described with an error (erfcs) function after short immersion times and with a parabolic (or quasi-parabolic) function after a longer immersion time in the salt bath.

In embodiments, the weight percentage of the lithium disilicate crystalline phase in the glass-ceramic articles of the disclosure can be in a range from 20 to 60 wt %, 20 to 55 wt %, 20 to 50 wt %, 20 to 45 wt %, 20 to 40 wt %, 20 to 35 wt %, 20 to 30 wt %, 20 to 25 wt %, 25 to 60 wt %, 25 to 55 wt %, 25 to 50 wt %, 25 to 45 wt %, 25 to 40 wt %, 25 to 35 wt %, 25 to 30 wt %, 30 to 60 wt %, 30 to 55 wt %, 30 to 50 wt %, 30 to 45 wt %, 30 to 40 wt %, 30 to 35 wt %, 35 to 60 wt %, 35 to 55 wt %, 35 to 50 wt %, 35 to 45 wt %, 35 to 40 wt %, 40 to 60 wt %, 40 to 55 wt %, 40 to 50 wt %, 40 to 45 wt %, 45 to 60 wt %, 45 to 55 wt %, 45 to 50 wt %, 50 to 60 wt %, 50 to 55 wt %, or 55 to 60 wt %, or any and all sub-ranges formed from any of these endpoints.

As also noted earlier, glass-ceramic articles derived from the glass precursor compositions of the disclosure can contain β-spodumene solid solution. β-spodumene solid solution, also known as stuffed keatite, possesses a framework structure of corner-connected SiO₄ and AlO₄ tetrahedra that form interlocking rings, which in turn create channels that contain Li ions. Glass-ceramic articles of the disclosure based on the β-spodumene phase can be chemically strengthened in a salt bath, during which Na⁺ (and/or K⁺) replaces Lit in the β-spodumene structure, which causes surface compression and strengthening.

As noted earlier, glass-ceramic articles derived from the glass precursor compositions of the disclosure can contain one or more Zr-based crystalline phases. Monoclinic ZrO₂ (baddeleyite) is an important geological mineral that has been comprehensively investigated to understand its monoclinic-tetragonal-cubic phase transition and its relation to the stabilization of tetragonal ZrO₂ ceramics. Structural ceramics based on stabilized tetragonal ZrO₂ have demonstrated excellent mechanical performance attributed to a combination of multiple toughening mechanisms. Due to its high strength and toughness, resulting from tetragonal to monoclinic phase transformation, ZrO₂ is widely used as advanced functional or structural ceramics in dentistry, electronics and grinding industry. Additionally, its high refractive index (n=2.16) makes ZrO₂ an excellent white refractive coating material within the glass-ceramic articles of the disclosure.

In some embodiments, the weight percentage of the one or more ZrO₂-containing crystalline phases in the glass-based articles of the disclosure can be in a range from 0.5 to 4.0 wt %, 0.5 to 3.5 wt %, 0.5 to 3.0 wt %, 0.5 to 2.5 wt %, 0.5 to 2.0 wt %, 0.5 to 1.5 wt %, 0.5 to 1.0 wt %, 1.0 to 4.0 wt %, 1.0 to 3.5 wt %, 1.0 to 3.0 wt %, 1.0 to 2.5 wt %, 1.0 to 2.0 wt %, 1.0 to 1.5 wt %, or any and all sub-ranges formed from any of these endpoints.

In some embodiments, the glass-ceramic articles of the disclosure have a residual glass content of 0 to 15 wt %, 0 to 10 wt %, 0 to 5 wt %, 1 to 10 wt %, 1 to 7.5 wt %, 1 to 5 wt %, 1 to 2.5 wt %, 1.5 to 7.5 wt %, 1.5 to 5 wt %, 1.5 to 4 wt %, 1.5 to 3 wt %, 2 to 5 wt %, 2 to 4 wt %, or 2 to 3 wt %, as determined according to Rietveld analysis of the XRD spectrum. It should be understood that the residual glass content may be within a sub-range formed from any and all of the foregoing endpoints.

This invention relates to production of opaque white spodumene/lithium disilicate/ZrO₂ glass-ceramics. This class of glass-ceramics possesses a high strength and high fracture toughness, composed of interlocking lithium silicate crystals in a glassy matrix along with β-spodumene grains >150 nm in size, resulting in a high fracture toughness and high body strength. The presence of high-index phases such as ZrO₂ produces a white opaque color in this group of glass-ceramics. Furthermore, the presence of an ion-exchangeable phase (β-spodumene) enables the development of a surface compression layer for improved mechanical performance.

The color and opacity of the glass-ceramic articles of the disclosure can be strongly dependent on the amount of ZrO₂ crystals that can be precipitated in the material during the ceramming process (also referred interchangeably herein as a “ceram process”). The nature and amount of the different crystalline phases that can be precipitated are typically controlled by the combined influences of the glass composition and the thermal treatment (ceramming) applied to the precursor glass composition to produce the glass-ceramic article. As noted earlier, the ZrO₂ crystalline amount in these glass-ceramic articles can be impacted by the concentration of Na₂O and K₂O in the precursor glass composition, with higher concentrations of these elements leading to lower ZrO₂ crystalline amounts precipitated for a given ceramming cycle.

Further, according to some embodiments, the amount of ZrO₂ crystals in the resulting glass-ceramic articles can be controlled for a given precursor glass composition with a given ceram cycle by controlling or otherwise understanding the amount of dissolved water (β-OH content) in the glass. Without being bound by theory, the water content in the precursor glass composition can be understood or otherwise controlled, while also adjusting the ceramming cycle, to obtain high amounts of ZrO₂ crystalline phases, which results in higher opacity in the resulting glass-ceramic article. According to some embodiments, the melting process can be controlled in order to obtain precursor glasses with different dissolved water (β-OH) contents to promote and maximize crystallization of ZrO₂ crystalline phases in the glass-ceramic articles with given ceramming recipes.

According to implementations of the glass-ceramic articles of the disclosure, the articles have a phase assemblage composed of the following crystals: β-spodumene solid solution crystals in the 0.5 to 2 μm size range, lithium disilicate needles with a length of 0.5 to 2 μm and a width of 100 to 500 nm and homogeneously dispersed zirconium-based crystals (zirconia, zircon, and/or K₂Zr₂O₅) in the 50 to 500 nm size range, lithium phosphate crystals in the 50 to 500 nm size range, with sogdianite present as a minor phase (0 wt % to <2 wt %). Without being bound by theory it is believed that the larger lithium disilicate grains and dispersed ZrO₂ phases partitioned at β-spodumene solid solution grain boundaries contribute to the higher fracture toughness of the glass-ceramic articles of the disclosure.

According to embodiments of the glass precursor compositions and glass-ceramic articles of the disclosure, the glass precursor composition can be adjusted or otherwise selected to possess a β-OH content from 0.1/mm to 0.5/mm or from 0.15 to 0.4/mm. In embodiments, the glass-ceramic articles can be derived from a precursor glass composition comprising 0.5/mm, 0.45/mm, 0.40/mm, 0.35/mm, 0.30/mm, 0.22/mm, 0.25/mm, 0.20/mm, 0.17/mm, 0.16/mm, 0.15/mm, 0.1/mm, or any and all sub-ranges formed between any of these values or endpoints.

According to one or more embodiments, the glass-ceramic articles of the disclosure can exhibit opacity from about 60 to 97%, from about 65 to 97%, or from about 75 to 95%, as measured through the article with a thickness of about 0.5 mm. In embodiments, the glass-ceramic articles exhibit opacity of about 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, or any and all sub-ranges formed between any of these values or endpoints. Further, in some embodiments, the glass-ceramic articles formed of the precursor glass compositions described herein are opaque. That is, these glass-ceramic articles have an average transmittance of less than 20% when measured at normal incidence for light in a wavelength range from 400 nm to 800 nm (inclusive of endpoints) at an article thickness of 0.8 mm.

According to one or more embodiments, the glass-ceramic articles of the disclosure are white or substantially white in color. Embodiments of the glass-ceramic articles of the disclosure can exhibit a reflected color given by L* from 80 to 98, a* from −3.0 to +3.0, and b* from −10.0 to +5.0 in the CIE color coordinate system. In some embodiments, the glass-ceramic articles of the disclosure exhibit a reflected color given by L* from 80 to 98, a* from −2.0 to 0, and b* from −8.0 to 0 in the CIE color coordinate system. According to another implementation, the glass-ceramic articles of the disclosure exhibit a reflected color given by L* from 85 to 98, a* from −3.0 to +3.0, and b* from −5.0 to +5.0 in the CIE color coordinate system.

According to one or more embodiments, the glass-ceramic articles of the disclosure exhibit a fracture toughness (K_{IC}) of from 1.0 to 3.0 MPa*m^{1/2}, as measured using the Chevron Notch Short Bar test method described in ASTM E 1304-97. In some implementations, the glass-ceramic articles of the disclosure exhibit a fracture toughness (K_{IC}) of from 1.5 to 3.0 MPa*m^{1/2}, as measured using the Chevron Notch Short Bar test method described in ASTM E 1304-97. In embodiments, the glass-ceramic articles exhibit a fracture toughness (K_{IC}) of 3.0, 2.8, 2.6, 2.4, 2.2, 2.0, 1.8, 1.6, 1.4, 1.2, 1.0 MPa*m^{1/2}, or any and all sub-ranges formed between any of these values or endpoints.

According to one or more embodiments, the glass-ceramic articles of the disclosure (non, ion-exchanged, strengthened articles) exhibit a Knoop hardness of greater than 500, 550, or even 600 kgf/mm². In some implementations, the glass-ceramic articles of the disclosure exhibit a Knoop hardness of 500, 525, 550, 575, 600, 625, 650, 675, 700 kgf/mm², or any and all sub-ranges formed between any of these values or endpoints.

According to some embodiments, the glass-ceramic articles of the disclosure exhibit an elastic modulus of greater than 85 GPa, 90 GPa, or even 95 GPa, as measured in accordance with ASTM C623. In some implementations, the glass-ceramic articles of the disclosure exhibit an elastic modulus of 85 GPa, 87.5 GPa, 90 GPa, 92.5 GPa, 95 GPa, 97.5 GPa, or any and all sub-ranges formed between any of these values or endpoints.

According to some implementations of the glass-ceramic articles of the disclosure, the articles can exhibit exemplary mechanical property performance in terms of no failures in the Drop Test Method when samples are subjected to a drop height of at least 160 cm onto 80 grit sandpaper and/or a drop height of at least 110 cm onto 60 grit sandpaper. In some embodiments, glass-ceramic articles of the disclosure can survive a drop height of 160 cm, 170 cm, or even 180 cm, onto 80 grit sandpaper according to the Drop Test Method. In some embodiments, glass-ceramic articles of the disclosure can survive a drop height of 110 cm, 120 cm, or even 130 cm, onto 60 grit sandpaper according to the Drop Test Method.

According to another implementation of the glass-ceramic articles of the disclosure, as subjected to an ion-exchange process (see subsequent disclosure), these articles can exhibit an applied fracture stress (through a 4-point bend test) of at least 400 MPa after a damage introduction with 180 grit sandpaper, at least 350 MPa after a damage introduction with 80 grit sandpaper, and/or at least 300 MPa after damage introduction with 30 grit sandpaper, according to the Retained Strength Test Method. In some embodiments, glass-ceramic articles of the disclosure can exhibit an applied fracture stress (through a 4-point bend test) of at least 400 MPa, 450 MPa, or even 500 MPa, after a damage introduction with 180 grit sandpaper according to the Retained Strength Test Method. In some embodiments, glass-ceramic articles of the disclosure can exhibit an applied fracture stress (through a 4-point bend test) of at least 350 MPa, 400 MPa, or even 450 MPa, after a damage introduction with 80 grit sandpaper according to the Retained Strength Test Method. In some embodiments, glass-ceramic articles of the disclosure can exhibit an applied fracture stress (through a 4-point bend test) of at least 300 MPa, 350 MPa, or even 400 MPa, after a damage introduction with 30 grit sandpaper according to the Retained Strength Test Method.

The glass-ceramic articles formed from the precursor glass compositions described herein may be any suitable thickness, which may vary depending on the particular application for use of the glass-ceramic article. In embodiments, the glass-ceramic articles may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

In embodiments, the processes for making the glass-ceramic article includes heat treating the precursor glass composition, such as in an oven, at one or more preselected temperatures for one or more preselected times to induce crystallization (i.e., nucleation and growth) of one or more crystalline phases (e.g., having one or more compositions, amounts, morphologies, sizes or size distributions, etc.). In embodiments, the heat treatment may include (i) heating a precursor glass composition in an oven at a rate greater than or equal to 1° C./min and less than or equal to 10° C./min to a nucleation temperature: (ii) maintaining the precursor glass composition at the nucleation temperature in the oven for time greater than or equal to 0.25 hour and less than or equal to 5 hours to produce a nucleated crystallizable glass: (iii) heating the nucleated crystallizable glass in the oven at a rate greater than or equal to 1° C./min and less than or equal to 10° C./min to a crystallization temperature: (iv) maintaining the nucleated crystallizable glass at the crystallization temperature in the oven for a time greater than or equal to 0.25 hour and less than or equal to 5 hours to produce the glass-ceramic article: and (v) cooling the glass-ceramic article to room temperature. The heating rates disclosed herein refer to the rate of temperature change in the environment, such as the rate of temperature change of the oven. According to embodiments, the precursor glass composition is held at the nucleation temperature according to (ii) from about 3 hours to 5 hours, e.g., 3 hours, 3.5 hours, 4.0 hours, 4.5 hours, 5.0 hours, and all durations between these values. According to embodiments, the precursor glass composition is held at the crystallization temperature according to (iv) from about 3 hours to 5 hours, e.g., 3 hours, 3.5 hours, 4.0 hours, 4.5 hours, 5.0 hours, and all durations between these values.

In embodiments, the nucleation temperature may be greater than or equal to 600° C. and less than or equal to 900° C. In embodiments, the nucleation temperature may be greater than or equal to 600° C. or even greater than or equal to 650° C. In embodiments, the nucleation temperature may be less than or equal to 900° C. or even less than or equal to 800° C. In embodiments, the nucleation temperature may be greater than or equal to 600° C. and less than or equal to 900° C., greater than or equal to 600° C. and less than or equal to 800° C., greater than or equal to 650° C. and less than or equal to 900° C., or even greater than or equal to 650° C. and less than or equal to 800° C., or any and all sub-ranges formed from any of these endpoints. In some embodiments, the nucleation temperature employed for the precursor glass compositions is 680° C., 700° C., 720° C., 740° C., 760° C., 780° C., 800° C., 820° C., and any nucleation temperatures between these values. The nucleation temperatures herein refer to the temperature of the environment in which the nucleation takes place, such as the temperature of an oven.

In embodiments, the crystallization temperature may be greater than or equal to 700° C. and less than or equal to 1000° C. In embodiments, the crystallization temperature may be greater than or equal to 700° C. or even greater than or equal to 750° C. In embodiments, the crystallization temperature may be less than or equal to 1000° C. or even less than or equal to 900° C. In embodiments, the crystallization temperature may be greater than or equal to 700° C. and less than or equal to 1000° C., greater than or equal to 700° C. and less than or equal to 920° C., greater than or equal to 750° C. and less than or equal to 1000° C., or even greater than or equal to 750° C. and less than or equal to 920° C., or any and all sub-ranges formed from any of these endpoints. In some embodiments, the crystallization temperature employed for the precursor glass compositions is 825° C., 850° C., 875° C., 890° C., 900° C., 920° C., 925° C., and any crystallization temperatures between these values. The crystallization temperatures herein refer to the temperature of the environment in which the crystallization takes place, such as the temperature of an oven.

One skilled in the art would understand that the heating rates, nucleation temperature, and crystallization temperature described herein refer to the heating rate and temperature of the oven in which the precursor glass composition is being heat treated to produce the glass-ceramic articles of the disclosure.

In addition to the precursor glass compositions, temperature-temporal profiles of heat treatment steps of heating to the crystallization temperature and maintaining the temperature at the crystallization temperature are judiciously prescribed so as to produce one or more of the following desired attributes: crystalline phase(s) of the glass-ceramic article, proportions of one or more major crystalline phases and/or one or more minor crystalline phases and residual glass phases, crystal phase assemblages of one or more predominant crystalline phases and/or one or more minor crystalline phases and residual glass phases, and grain sizes or grain size distribution among one or more major crystalline phases and/or one or more minor crystalline phases, which in turn may influence the final integrity, quality, color, and/or opacity of the resulting glass-ceramic article.

As noted earlier, embodiments of the glass precursor compositions and glass-ceramic articles of the disclosure can be adjusted or otherwise selected to possess a β-OH content from 0.1/mm to 0.5/mm, or from 0.15 to 0.4/mm. Without being bound by theory, the ceramming process for forming glass-ceramic articles from precursor glass compositions of the disclosure can be adjusted (e.g., by adjusting the nucleation temperature, nucleation duration, crystallization temperature, and/or crystallization duration) in view of β-OH content present in the glass composition to maximize the crystallization of ZrO₂ crystalline phases and obtain a glass-ceramic article with higher opacity and/or fracture toughness. Further, without being bound by theory, it is expected that higher amounts of the ZrO₂ crystalline phase and corresponding levels of opacity will be found in glass-ceramic articles derived from glass precursor compositions with higher β-OH content, for a given ceramming process condition. In addition, it is expected that higher amounts of ZrO₂ crystalline phases and corresponding levels of opacity will be found in glass-ceramic articles derived from glass precursor compositions with the same β-OH content, but as subjected to higher crystallization temperatures and/or crystallization durations. That is, prior knowledge of a low β-OH content of a precursor glass composition can be employed to optimize the ceramming process with a higher crystallization temperature and/or crystallization duration to produce higher amounts of the ZrO₂ crystalline phase in the resulting glass-ceramic articles, thus contributing to higher levels of opacity.

The resulting glass-ceramic article may be provided as a sheet, which may then be reformed by pressing, blowing, bending, sagging, vacuum forming, or other means into curved or bent pieces of uniform thickness. Reforming may be done before thermally treating or the forming step may also serve as a thermal treatment step in which both forming and thermal treating are performed substantially simultaneously.

In embodiments, the glass-ceramic articles described herein are ion exchangeable to facilitate strengthening the article made from the precursor glass compositions of the disclosure. In typical ion exchange processes, smaller metal ions in the glass-ceramic articles are replaced or “exchanged” with larger metal ions of the same valence within a layer that is close to the outer surface of the glass-ceramic article made from the precursor glass composition. The replacement of smaller ions with larger ions creates a compressive stress within the layer of the glass-ceramic article made from the precursor glass composition. In embodiments, the metal ions are monovalent metal ions (e.g., Li⁺, Na⁺, K⁺, and the like), and ion exchange is accomplished by immersing the glass-ceramic article made from the precursor glass composition in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions.

According to embodiments, the glass-ceramic articles of the disclosure can be subjected to an ion-exchange process in a NaNO₃- or KNO₃-containing or a mixed molten salt bath. Lithium ions in β-spodumene solid solution and in the residual glass phase can be easily replaced by Na⁺ or K⁺ ions in a molten salt bath. During ion exchange, the glass-ceramic article is held in a salt bath for a sufficient time for exchange to occur on the surface and into some depth into the article. As a result of the ion exchange, a surface compressive (CS) layer is created by the substitution of Li and/or Na contained in a surface layer by Na or K having a larger ionic radius during chemical strengthening, resulting in increased mechanical performance in terms of the Drop Test Method and/or Retained Strength Test Method. The ion exchange process or processes that are used to strengthen the glass-ceramic article made from the precursor glass composition may include, but are not limited to, immersion in a single bath or multiple baths of like or different compositions with washing and/or annealing steps between immersions. According to an embodiment, the bath composition can comprise 58-62 wt % KNO₃ (e.g., 60 wt % KNO₃), 38-42 wt % NaNO₃ (e.g., 40 wt % NaNO₃), and an optional small amount of LiNO₃ (e.g., 0.01-1 wt %, 0.12 wt %, etc.) set at a bath temperature from 475° C. to 550° C.(e.g., 500° C.).

Upon exposure to the glass-ceramic articles, the ion exchange solution (e.g., KNO₃ and/or NaNO₃ molten salt bath) may, according to embodiments, be at a temperature that is ≥350° C. and ≤550° C., ≥350° C. and ≤500° C., ≥360° C. and ≤450° C., ≥370° C. and ≤440° C., ≥360° C. and ≤420° C., ≥370° C. and ≤400° C., ≥375° C. and ≤475° C., ≥400° C. and ≤500° C., ≥410° C. and ≤490° C., ≥420° C. and ≤480° C., ≥430° C. and ≤470° C., or even ≥440° C. and ≤460° C., or any and all sub-ranges between the foregoing values. In embodiments, the glass-ceramic article may be exposed to the ion exchange solution for a duration that is >2 hours and ≤48 hours, >2 hours and ≤24 hours, ≥2 hours and ≤12 hours, >2 hours and ≤6 hours, >8 hours and ≤44 hours, ≥12 hours and ≤40 hours, ≥16 hours and ≤36 hours, ≥20 hours and ≤32 hours, or even ≥24 hours and ≤28 hours, or any and all sub-ranges between the foregoing values.

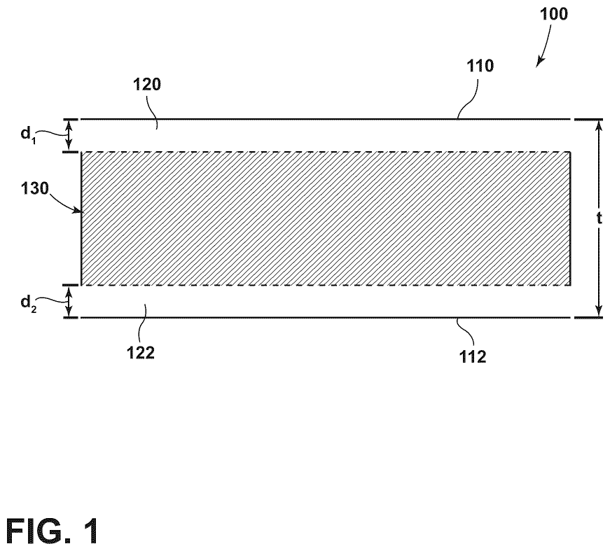

As mentioned above, in embodiments, the glass-ceramic article may be strengthened, such as by ion exchange, making a glass-ceramic article that is damage resistant for applications such as, but not limited to, glass for device housings. With reference to FIG. 1, the glass-ceramic article 100 has a first region under compressive stress (e.g., a region in which smaller alkali metal ions, e.g., Na⁺ ions, have been substantially exchanged for larger alkali metal ions, e.g., K⁺ ions) extending from the surface to a DOC of the glass-ceramic substrate and a second region (e.g., central region 130 in FIG. 1) extending from the DOC into the central or interior region of the glass. A first compressive layer 120 extends from first surface 110 to a depth d₁ and a second compressive layer 122 extends from second surface 112 to a depth d₂. Together, these segments define a compressive stress region of the glass-ceramic article 100.

In embodiments, the DOC of the glass-ceramic articles may be in the range from >0.14t to ≤0.24t where t is the thickness of the articles, such as from ≥0.15t to ≤0.24t, from ≥0.16 to ≤0.24t, from ≥0.17t to ≤0.24t, from ≥0.18t to ≤0.24t, from ≥0.19t to ≤0.24t, from ≥0.20t to ≤0.24t, from ≥0.21t to ≤0.24t, from ≥0.22t to ≤0.24t, from ≥0.23t to ≤0.24t, from ≥0.14t to ≤0.23t, from ≥0.15t to ≤0.23t, from ≥0.16t to ≤0.23t, from ≥0.17t to ≤0.23t, from ≥0.18t to ≤0.23t, from ≥0.19t to ≤0.23t, from ≥0.20t to ≤0.23t, from ≥0.21t to ≤0.23t, from ≥0.22t to ≤0.23t, from ≥0.14t to ≤0.22t, from ≥0.15t to ≤0.22t, from ≥0.16t to ≤0.22t, from ≥0.17t to ≤0.22t, from ≥0.18t to ≤0.22t, from ≥0.19t to ≤0.22t, from ≥0.20t to ≤0.22t, from ≥0.21t to ≤0.22t, from ≥0.14t to ≤0.21t, from ≥0.15t to ≤0.21t, from ≥0.16t to ≤0.21t, from ≥0.17t to ≤0.21t, from ≥0.18t to ≤0.21t, from ≥0.19t to ≤0.21t, from ≥0.20t to ≤0.21t, from ≥0.14t to ≤0.20t, from ≥0.15t to ≤0.20t, from ≥0.16t to ≤0.20t, from ≥0.17t to ≤0.20t, from ≥0.18t to ≤0.20t, from ≥0.19t to ≤0.20t, from ≥0.14t to ≤0.19t, from ≥0.15t to ≤0.19t, from ≥0.16t to ≤0.19t, from ≥0.17t to ≤0.19t, from ≥0.18t to ≤0.19t, from ≥0.14t to ≤0.18t, from ≥0.15t to ≤0.18t, from ≥0.16t to ≤0.18t, from >0.17t to ≤0.18t, from >0.14t to ≤0.17t, from ≥0.15t to ≤0.17t, from ≥0.16t to ≤0.17t, from ≥0.14t to ≤0.16t, from ≥0.15t to ≤0.16t, from ≥0.14t to ≤0.15t, including any and all sub-ranges between the foregoing values.

In embodiments, the DOC of the glass-ceramic articles may be from 50 μm to 250 μm, 75 μm to 200 μm, or from 100 μm to 200 μm. According to some embodiments, the DOC of the glass-ceramic articles can be 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, and any DOC levels between the foregoing values.

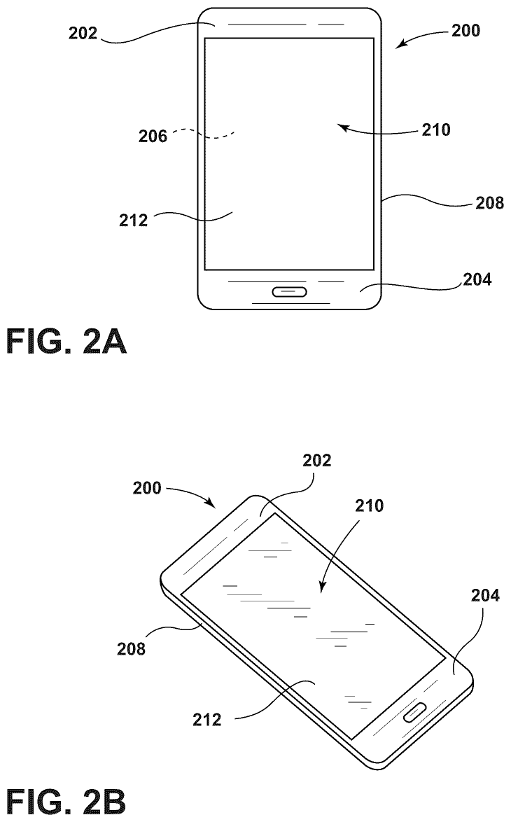

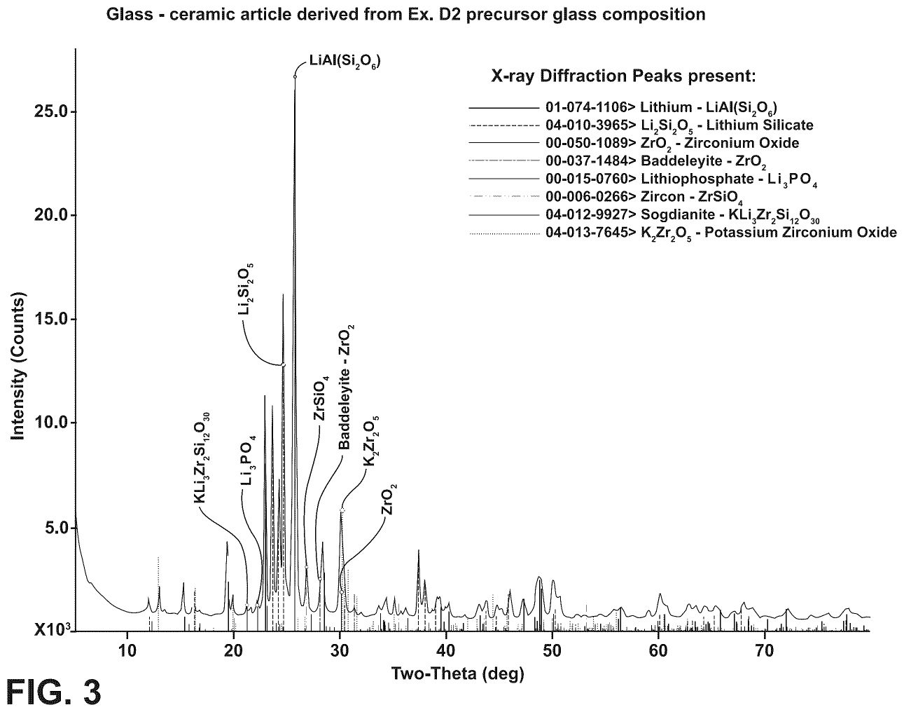

An exemplary electronic device incorporating any of the glass-ceramic articles disclosed herein is shown in FIGS. 2A and 2B. Specifically, FIGS. 2A and 2B show a consumer electronic device 200 (e.g., a mobile device) including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass-ceramic articles disclosed herein.

### EXAMPLES

The embodiments described in this disclosure are further clarified by the following examples.

### Example 1

In this example, a range of ceramming conditions was evaluated for developing glass-ceramic articles derived from two (2) glass precursor compositions of the disclosure, Ex. D1 and Ex. D2 (see Table 2 above). For each precursor glass composition, a sample precursor glass was placed in a box furnace, the box furnace was heated to a 1^{st} temperature (“nucleation temperature”) and held at the 1^{st} temperature for 4 hours. The box furnace was then heated to a 2^{nd} higher temperature (“crystallization temperature”) and held at the 2^{nd} temperature for 4 hours prior to a cool down. The phase assemblage obtained in the cerammed samples was measured by XRD. Some samples were optically polished into plane-parallel samples with 0.5 mm thickness, and color and opacity were measured. Further, the fracture toughness (K_{IC}) of the cerammed glass-ceramic articles was measured according to the Chevron Notch Short Bar Method.

The phase assemblage obtained from the glass-ceramic articles derived from the Ex. D1 and Ex. D2 precursor glass compositions, as cerammed with various ceram cycles, as well as the fracture toughness for these samples is presented in Table 3 below. The color and opacity measured on the samples on black and white backgrounds is also presented in Table 4.

As is evident from Table 3, the cerammed glass-ceramic articles from the Ex. D2 precursor glass composition show lithium disilicate (Li₂Si₂O₅) and beta-spodumene as the main phases, with smaller amount of lithium phosphate (Li₃PO₄), ZrO₂ (tetragonal and/or baddeleyite) phases. Small amounts of zircon (ZrSiO₄), K₂Zr₂O₅ and sogdianite are also present, and these minor phases are not present in the glass-ceramic articles derived from the Ex. D1 precursor glass composition. Note that while the glass wt % is reported as 0.0 wt %, it is believed that some amount of residual glassy phase is present in the material, but the amount cannot be calculated accurately with the Rietveld method. It is believed the actual wt % of glassy phase is <5 wt %.

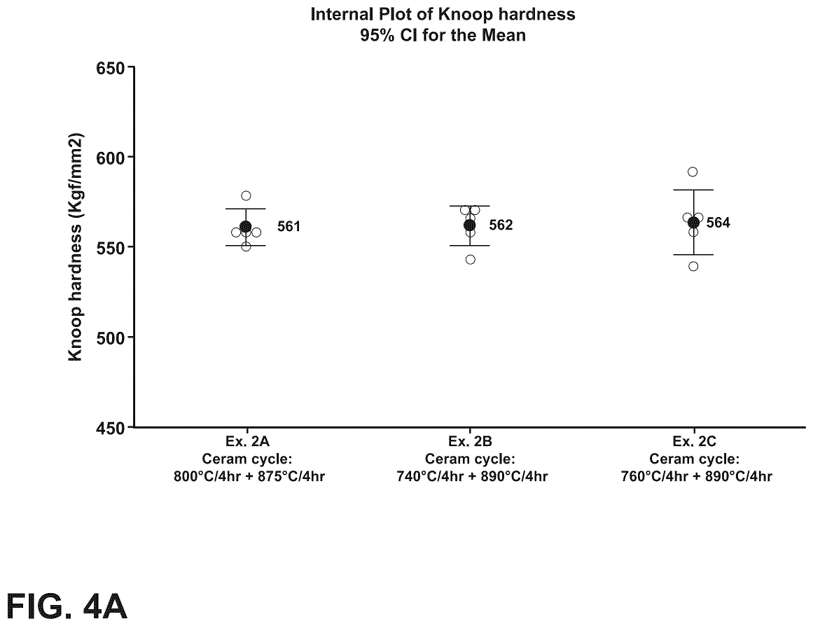

Referring now to FIG. 3, an x-ray diffraction (XRD) spectrum is provided for a glass-ceramic article of this example derived from the Ex. D2 precursor glass composition, and cerammed with nucleation at 740° C. for 4 hours and crystallization at 890° C. for 4 hours. The phase assemblage for this glass-ceramic is as shown in FIG. 3.

As is also evident from Table 3, the fracture toughness (K_{IC}) measured on the glass-ceramic articles derived from the Ex. D2 precursor glass composition is about 1.65 MPa*m^{1/2} or greater, and up to 1.91 MPa*m^{1/2} for the samples cerammed with nucleation at 700° C. or 740° C. for 4 hours and crystallization at 890° C. for 4 hours. Fracture toughness values range from 1.54 MPa*m^{1/2} to 1.72 MPa*m^{1/2} for the glass-ceramic articles derived from the Ex. D1 precursor glass composition. Without being bound by theory, it is believed that the relatively higher amounts of the lithium disilicate phase present in these glass-ceramic articles contributes to their higher levels of fracture toughness as compared to other glass-ceramic articles in the LAS family.

As is evident from Table 4, the opacity of the glass-ceramic articles derived from the Ex. D2 precursor glass composition ranges from 77 to 93%. The color on black and white backgrounds obtained for these glass-ceramic articles show ranges of L* between 85 and 97. a* between −1.5 and 0. and b* between −8 and 0.

TABLE 3
Phase assemblages obtained by XRD for glass-ceramic articles derived from precursor
glass compositions at different nucleation and crystallization temperatures

| | | | Phase assemblage measured by XRD Rietveld | | | | | | | | | |
|---|---|---|---|---|---|---|---|---|---|---|---|---|
| | Nucleat. | Crystal. | | | β- | | Tetragonal | Badde- | | | | |
| Precursor | temp | temp | Glass | Li₂Si₂O₅ | spodumene | Li₃PO₄ | ZrO₂ | leyite | Zircon | K₂Zr₂O₅ | Sogdianite | K_{IC} |
| glass | (C.) | (C.) | (wt %) | (wt %) | (wt %) | (wt %) | (wt %) | (wt %) | (wt %) | (wt %) | (wt %) | (MPa · m½) |
| Ex. D1 | 800 | 875 | 0.0 | 43 | 50 | 3.5 | 2.4 | 0.8 | 0.0 | 0.0 | 0.0 | 1.54 |
| | 800 | 890 | 0.0 | 43 | 51 | 3.6 | 1.7 | 1.2 | 0.0 | 0.0 | 0.0 | 1.72 |
| Ex. D2 | 680 | 850 | 0.0 | 45 | 43 | 3.8 | 2.9 | 0.0 | 3.6 | 1.5 | 0.2 | ** |
| | 700 | 850 | 0.0 | 46 | 42 | 3.6 | 2.5 | 0.6 | 3.7 | 1.4 | 0.2 | ** |
| | 700 | 875 | 0.0 | 44 | 44 | 3.8 | 2.2 | 1.0 | 3.5 | 1.6 | 0.2 | ** |
| | 700 | 890 | 0.0 | 46 | 42 | 3.7 | 1.7 | 1.4 | 3.5 | 1.6 | 0.2 | 1.91 |
| | 720 | 875 | 0.0 | 45 | 43 | 3.8 | 2.3 | 0.9 | 3.6 | 1.5 | 0.2 | ** |
| | 720 | 890 | 0.0 | 46 | 42 | 3.6 | 1.6 | 1.6 | 3.5 | 1.5 | 0.2 | ** |
| | 740 | 850 | 0.0 | 47 | 42 | 2.9 | 3.0 | 0.0 | 3.4 | 1.7 | 0.2 | ** |
| | 740 | 875 | 0.0 | 48 | 40 | 3.6 | 2.4 | 0.8 | 3.4 | 1.6 | 0.2 | 1.70 |
| | 740 | 890 | 0.0 | 46 | 42 | 3.7 | 2.1 | 1.0 | 3.5 | 1.5 | 0.2 | 1.91 |
| | 760 | 890 | 0.0 | 45 | 43 | 3.7 | 2.3 | 0.9 | 3.4 | 1.5 | 0.2 | 1.82 |
| | 800 | 890 | 0.0 | 47 | 41 | 3.7 | 2.6 | 0.6 | 3.5 | 1.6 | 0.2 | 1.65 |
| | 800 | 920 | 0.0 | 51 | 40 | 3.7 | 0 | 0 | 4.4 | 1.3 | 0.3 | 1.89 |

TABLE 4
Color and opacity for glass-ceramic articles derived from precursor glass
compositions at different nucleation and crystallization temperatures

| | Nucleation | Crystallization | | | | | | | | Sample |
|---|---|---|---|---|---|---|---|---|---|---|
| Precursor | temp | temp | Opacity | Black background | | | White background | | | thickness |
| glass | (C.) | (C.) | (%) | L* | a* | b* | L* | a* | b* | (mm) |
| Ex. D1 | 800 | 875 | 85.5 | 89.41 | −1.6 | −6.97 | 95.14 | −0.55 | −1.14 | 0.50 |
| | 800 | 890 | 91 | 92.25 | −1.25 | −4.11 | 95.83 | −0.55 | −0.72 | 0.49 |
| Ex. D2 | 680 | 850 | 77.5 | 86.62 | −1.18 | −7.88 | 94.70 | −0.48 | −1.00 | 0.5 |
| | 700 | 850 | 76.8 | 85.37 | −1.08 | −7.90 | 94.61 | −0.48 | −0.89 | 0.48 |
| | 700 | 890 | 92.2 | 85.14 | −1.06 | −8.01 | 94.60 | −0.48 | −0.92 | 0.49 |
| | 740 | 850 | 79.9 | 92.87 | −0.96 | −3.13 | 95.90 | −0.46 | −0.49 | 0.54 |
| | 740 | 890 | 92.6 | 93.22 | −0.86 | −2.84 | 96.07 | −0.43 | −0.53 | 0.45 |
| | 760 | 890 | 91.7 | 92.63 | −1.16 | −4.06 | 95.88 | −0.50 | −0.93 | 0.54 |
| | 800 | 890 | 85.2 | 89.30 | −1.48 | −6.69 | 95.18 | −0.49 | −1.24 | 0.42 |

### Example 2

In this example, glass-ceramic articles are derived from precursor glass compositions of the disclosure (Ex. D1 and Ex. D2) as follows: Ex. 2A, precursor glass of Ex. D1 with nucleation at 800° C. for 4 hours and crystallization at 875° C. for 4 hours; Ex. 2B, precursor glass of Ex. D2 with nucleation at 740° C. for 4 hours and crystallization at 890° C. for 4 hours; and Ex. 2C, precursor glass of Ex. D2 with nucleation at 760° C. for 4 hours and crystallization at 890° C. for 4 hours. The color and opacity data measured on the samples from this example on black and white backgrounds are presented below in Table 5.

Notably, glass-ceramic articles derived from the Ex. D2 precursor glass composition (Exs. 2B and 2C) showed higher opacity than glass-ceramic articles derived from the Ex. D1 precursor glass compositions (Ex. 2A).

TABLE 5
Color and opacity for glass-ceramic articles with a thickness
of 0.5 mm derived from precursor glass compositions at different
nucleation and crystallization temperatures

| | | White background | | | Black background | | |
|---|---|---|---|---|---|---|---|
| | Opacity | L* | a* | b* | L* | a* | b* |
| Ex. 2A (800° C./ | 85.5 | 95.14 | −0.55 | −1.14 | 89.41 | −1.6 | −6.97 |
| 4 hr + | | | | | | | |
| 875° C./4 hr) | | | | | | | |
| Ex. 2B (740° C./ | 93.5 | 96.42 | −0.44 | −0.56 | 93.85 | −0.86 | −2.71 |
| 4 hr + | | | | | | | |
| 890° C./4 hr) | | | | | | | |
| Ex. 2C (760° C./ | 90.9 | 96.03 | −0.48 | −1.07 | 92.47 | −1.20 | −4.43 |
| 4 hr + | | | | | | | |
| 890° C./4 hr) | | | | | | | |

The Young's modulus, shear modulus and Poisson's ratio values measured on the glass-ceramic samples from this example using resonant ultrasonic spectroscopy according to ASTM E2001-13 are presented below in Table 6. Fracture toughness (K_{IC}) values are also presented in Table 6, as measured using the Chevron Notch Short Bar test method described in ASTM E 1304-97. As is evident from this table, the mechanical properties for the glass-ceramic samples derived from the Ex. D1 and Ex. D2 precursor glass compositions are similar.

TABLE 6
Mechanical properties for glass-ceramic articles
derived from precursor glass compositions

| | |
|---|---|
| Ex. 2A | Ex. 2B |
| (800° C./4 hr + | (740° C./4 hr + |
| 875° C./4 hr) | 890° C./4 hr) |

| | | | | |
|---|---|---|---|---|
| Fracture | 1.54 | MPa · m^{1/2} | 1.91 | MPa · m^{1/2} |
| toughness (K_{IC}) | | | | |

| | | |
|---|---|---|
| Poissons Ratio | 0.24 | 0.24 |

| | | | | |
|---|---|---|---|---|
| Shear Modulus | 39 | GPa | 40 | GPa |
| Youngs Modulus | 96 | GPa | 99 | GPa |

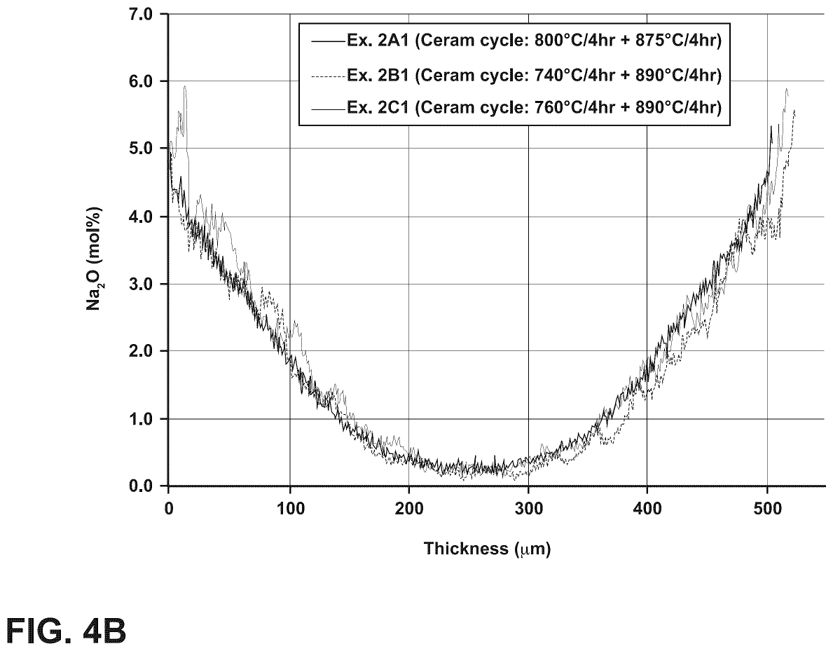

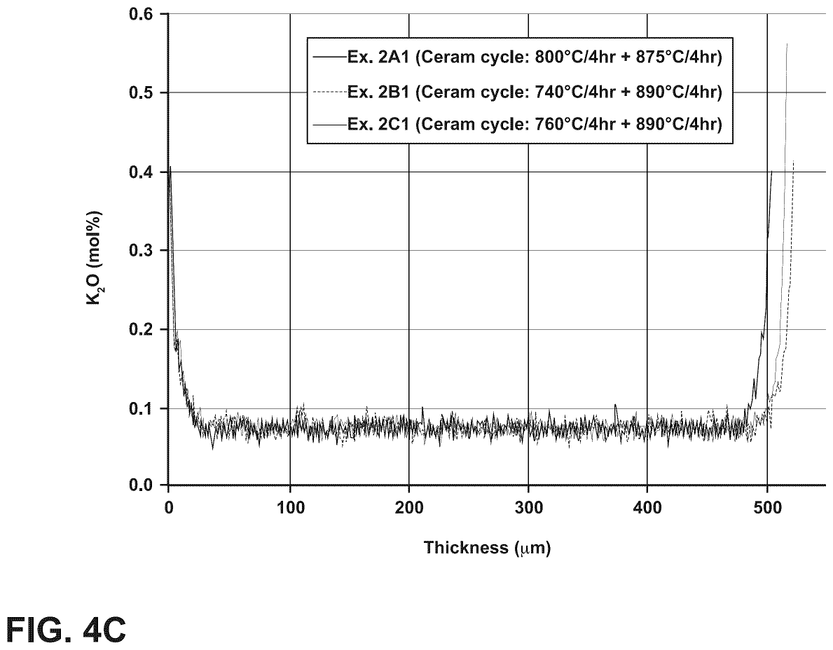

Referring now to FIG. 4A, a box plot of Knoop hardness levels for the three groups of glass-ceramic articles of this example (Exs. 2A-2C) is provided. As is evident from FIG. 4A, the glass-ceramic articles of this example, as derived from the Ex. D1 or Ex. D2 precursor glass composition, exhibit similar mean Knoop hardness levels, 561, 562 and 564 kg/mm₂, respectively.

### Example 3

In this example, the glass-ceramic articles of the previous example (Exs. 2A-2C) were subjected to an ion-exchange treatment for chemical strengthening. In particular, these articles were chemically strengthened by placing them in a molten salt bath comprising NaNO₃ and KNO₃ for a predetermined time period to achieve ion exchange. A depth-of-layer (DOL), determined from the resulting Na₂O and K₂O concentration profiles (see FIGS. 4B and 4C), of less than about 24% of the thickness of the article was achievable in glass-ceramic articles derived from the Ex. D2 glass precursor composition, as cerammed with a nucleation at 740° C./4 hr and crystallization at 890° C./4 hr or nucleation at 760° C./4 hr and crystallization at 890° C./4 hr, and then subjected to ion exchanging in a 60% KNO₃/40% NaNO₃ molten salt bath at 500° C. for 4 hours for 0.5 mm thick articles (Exs. 2B1 and 2C1, respectively). This DOL is similar to the DOL that was obtained on glass-ceramic articles derived from the Ex. D1 glass precursor composition, as cerammed with a nucleation at 800° C./4 hr and crystallization at 875° C./4 hr, and ion-exchanged in the same conditions (Ex. 2A1). Also, in this example, a small amount of lithium nitrate (0.01-1 wt %) was added to the molten salt bath prior to ion-exchanging to avoid formation of an amorphous layer at the surface of the samples.

As is evident from this example, the development of a compressive stress region is beneficial for achieving a better mechanical performance compared to non-ion-exchanged materials. Referring now to FIGS. 4B and 4C, microprobe profiles are provided of Na₂O and K₂O concentration, respectively, as a function of depth within the glass-ceramic articles of the previous example, as subjected to the ion exchange treatment of this example (Exs. 2A1-2C1). Further, it is evident from FIGS. 4B and 4C that a compressive stress region was developed in these samples that comprises at least 0.1 mol % K₂O at a depth of 10 μm or less from a primary surface of the article.

### Example 4

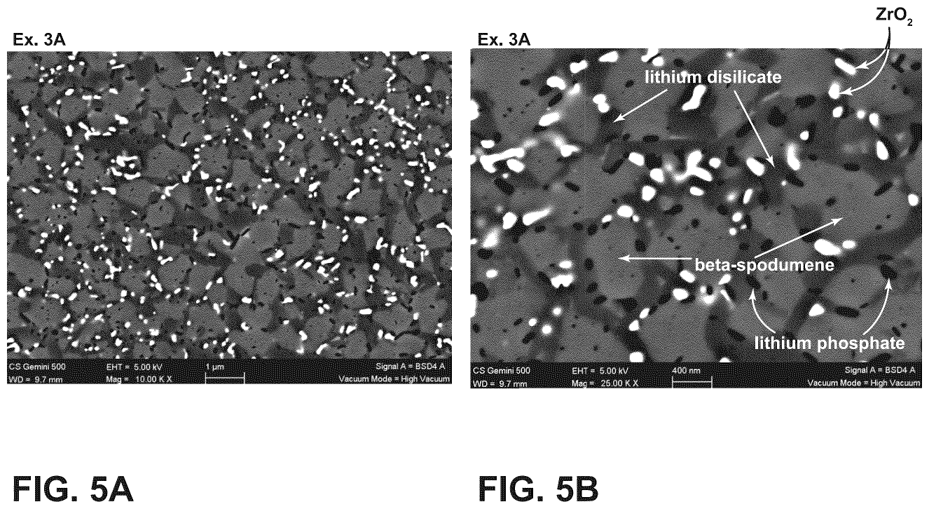

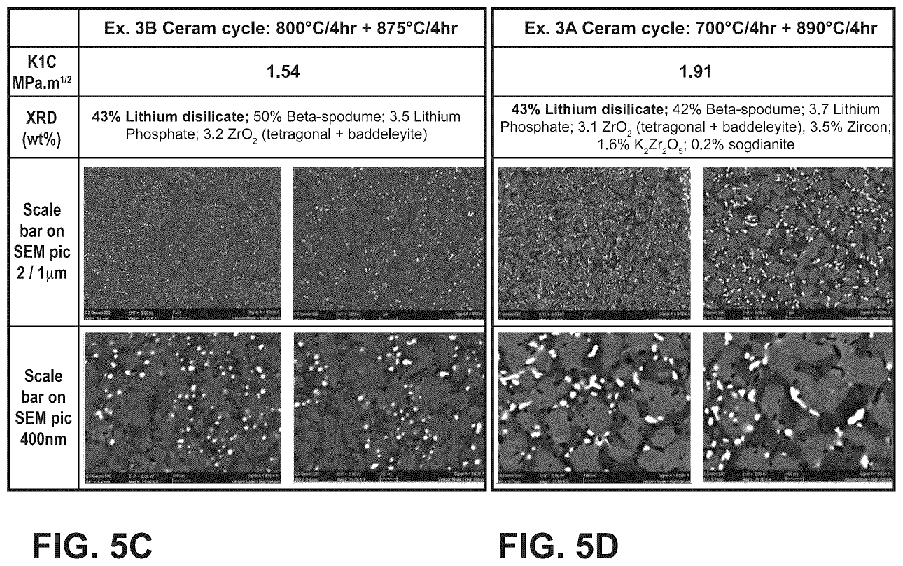

In this example, the microstructures of glass-ceramic articles derived from the Ex. D1 and Ex. D2 precursor glass compositions were evaluated, as cerammed with a nucleation at 800° C./4 hours and crystallization at 875° C./4 hr, and with a nucleation at 700° C./4 hours and crystallization at 890° C./4 hr (Exs. 3B and 3A, respectively). Referring to FIGS. 5A & 5B, the microstructure of Ex. 3A is provided in the form of scanning electron microscopy (SEM) images. As is evident from these figures, the white spots correspond to the ZrO₂ phase, acicular needles to lithium disilicate, black dots to lithium phosphate, and large grey blocks to β-spodumene solid solution.

Referring now to FIGS. 5C and 5D, SEM images are provided of both of the glass-ceramic articles of this example, Exs. 3A and 3B. In particular, in FIGS. 5C and 5D, the microstructure of FIGS. 5A and 5B (i.e., from Ex. 3A) is compared in detail to the microstructure of the other glass-ceramic articles of this example, Ex. 3B.

As is evident from FIGS. 5A-5D, the improved glass-ceramics presented in this disclosure present a crystalline phase assemblage composed of the following crystals: β-spodumene solid solution crystals in the 0.5 to 2 μm range, lithium disilicate needles with 0.5 to 2 μm length and 100 to 500 nm width, homogeneously dispersed Zr-based crystals (tetragonal zirconia, zircon, K₂Zr₂O₅) in the 50 to 500 nm range, and lithium phosphate crystals in the 50 to 500 nm range. With further regard to FIGS. 5C and 5D (for both Exs. 3A and 3B), the white spots correspond to the ZrO₂ phase, acicular needles to lithium disilicate, black dots to lithium phosphate, and large grey blocks to β-spodumene solid solution. Further, the percentages of these crystalline phases that are present in the glass-ceramic articles of this example are also shown in these figures.

### Example 5

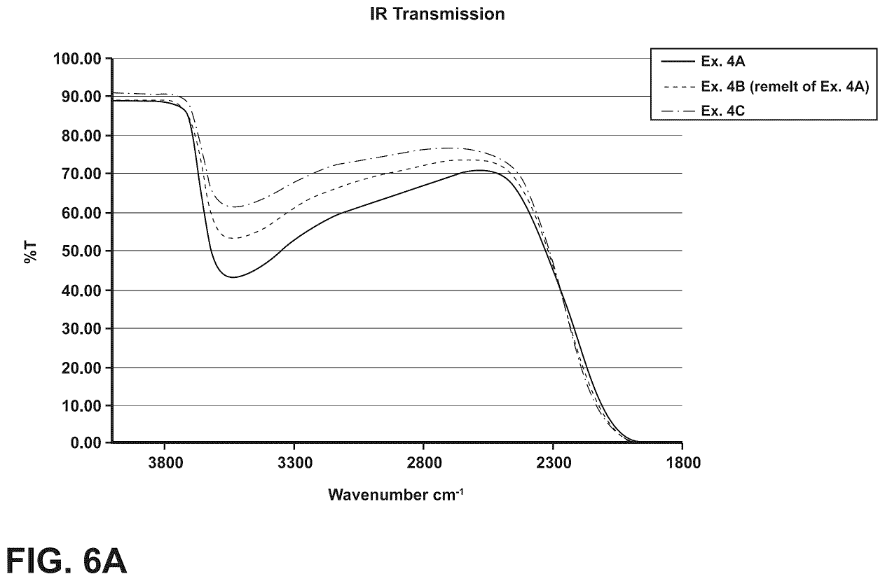

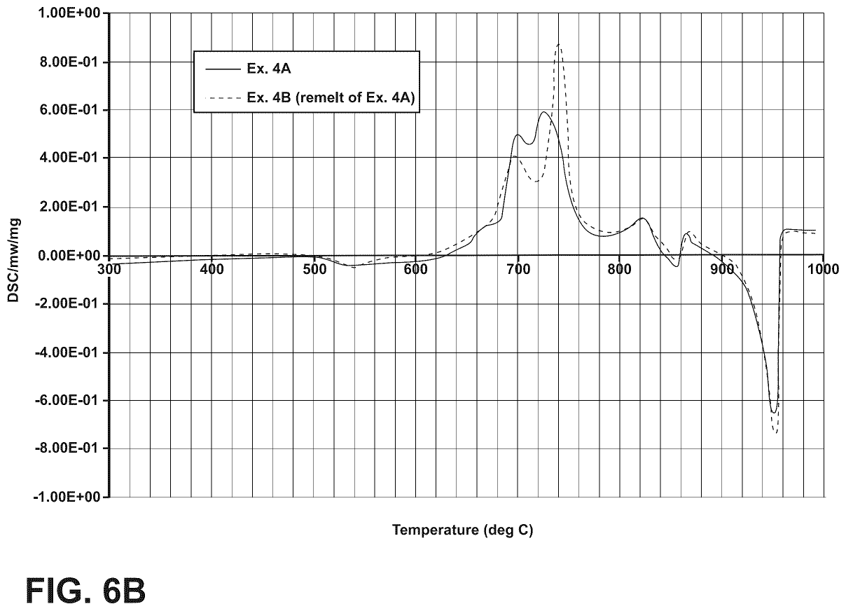

In this example, precursor glass compositions (from Exs. D1 and D2) according to the disclosure were melted or re-melted, as designated Exs. 4A-4C in this example. Table 7 below lists the precursor compositions and their melting conditions for this example, along with their measured β-OH content. As shown in FIG. 6A, a plot of transmittance vs. wavenumber in the near infrared (NIR) spectrum is provided for the glass compositions in Table 7 and this example with different β-OH measured content. The β-OH content is proportional to the absorption measured in the NIR spectrum at wavenumber of 3500 cm⁻¹, taken as a ratio to a baseline reference portion of the spectrum, here taken at 3846 cm⁻¹. Ultimately, these melted precursor glass compositions can be cerammed, according to the methods of the disclosure, to obtain glass-ceramic articles.

TABLE 7
Comparison of β-OH content in melted
and re-melted precursor glass compositions

| | Thick- | Ref. cm⁻¹ | OH cm⁻¹ | BOH |
|---|---|---|---|---|
| | ness | 3846 | min(3650-3300) | (abs/ |
| Sample ID | (mm) | Ref. % T | OH % T | mm) |
| Ex. 4A (derived from Ex. | 0.900 | 88.718 | 43.133 | 0.348 |
| D2 precursor glass) | | | | |
| Ex. 4B (remelt of | 1.011 | 89.101 | 53.089 | 0.222 |
| Ex. 4A) | | | | |
| Ex. 4C (derived from Ex. | 1.033 | 90.611 | 61.295 | 0.164 |
| D1 precursor glass) | | | | |

Referring now to FIG. 6B, a differential scanning calorimetry (DSC) plot is provided for two of the glass compositions in this example (Exs. 4A and 4B) having different β-OH content. The Ex. 4A glass, as derived from the Ex. D2 precursor glass composition, and a remelt of that glass, Ex. 4B, containing different β-OH levels also show differences in crystallization behavior, as can be seen from the difference in intensity and peak temperatures for the exothermic events (crystallization) in the 700-800° C. range. While this temperature range is known to be related to lithium silicate phases in this family of compositions, and not specifically zirconia, it highlights that the same glass composition, but with different β-OH levels, can exhibit different crystallization behavior. In particular, increased water content can lead to a decrease of the temperature of maximum growth during a subsequent ceramming process.

### Example 5A

In this example, XRD Rietveld analyses are conducted on the Ex. 4A glass and re-melted Ex. 4A glass, Ex. 4B, from the previous example, after ceramming with a nucleation at 700° C./4 hr and crystallization at 875° C./4 hr. Also evaluated are glasses similar in composition to Ex. 4A with high or low iron (Fe) and potassium (K) ion content, and re-melts of these glass, as cerammed under the same ceramming condition, i.e., nucleation at 700° C./4 hr and crystallization at 875° C./4 hr. In general, the re-melts of these glasses have lower β-OH content. The results of these analyses are presented below in Table 8. It can be seen from Table 8 that for a given ceramming cycle, here 700° C./4 h+875° C./4 h, the re-melts do systematically show lower total amounts of ZrO₂.

TABLE 8
XRD Rietveld analyses (wt %) for Ex. D2 precursor glass and their remelts, as cerammed
with nucleation at 700° C./4 hr and crystallization at 875° C./4 hr spodumene

| | | β- | | | | Tetragonal | | Total |
|---|---|---|---|---|---|---|---|---|
| Sample ID | Glass | spodumene | Li₂Si₂O₅ | Li₃(PO₄) | Baddeleyite | ZrO₂ | Virgilite | ZrO₂ |
| Ex. 4A1 (low Fe/K) | 5.8 | 49 | 40 | 3.5 | 0.4 | 1.5 | 0 | 1.8 |
| Ex. 4A1 - remelt | 9.9 | 48 | 38 | 3.3 | trace | 0.7 | trace | 0.7 |
| Ex. 4A2 (high Fe/K) | 12 | 46 | 38 | 3.1 | trace | 0.7 | 0 | 0.7 |
| Ex. 4A2 - remelt | 10 | 47 | 39 | 3.5 | 0.0 | 0.0 | 0 | 0.0 |
| Ex. 4A | 1.4 | 49 | 43 | 3.4 | 0.7 | 2.4 | 0 | 3.1 |
| Ex. 4B (remelt of Ex. 4A) | 8.4 | 48 | 40 | 3.6 | trace | 0.5 | 0 | 0.5 |

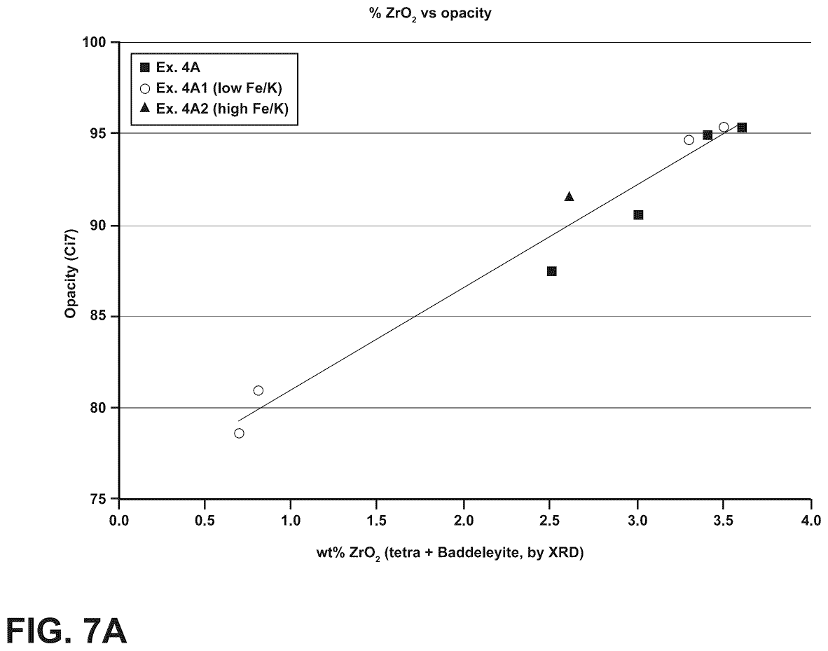

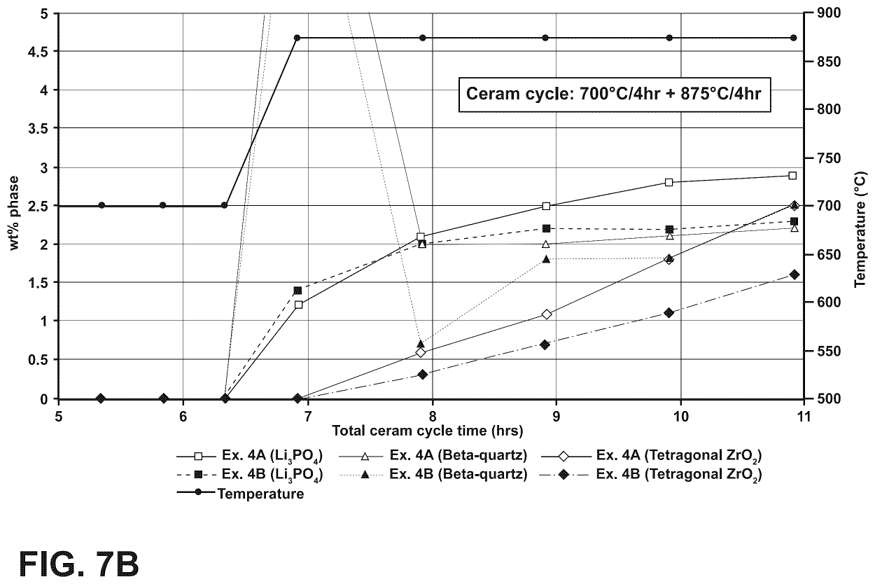

Referring now to FIG. 7A, a plot is provided of opacity vs. the amount of ZrO₂ in three of the glass-ceramic articles of this example (Exs. 4A, 4A1, and 4A2). As shown in FIG. 7A, the opacity of the glass-ceramics obtained in these white glass-ceramics derived from the Ex. D2 precursor glass composition is proportional to the amount of ZrO₂ precipitated during the ceramming cycle. Therefore, glasses with lower β-OH yield less opaque glass-ceramics than glasses with the same composition but higher β-OH, when cerammed with the same ceram cycle.

Referring now to FIG. 7B, a plot is provided of the minor phase amounts in two glass-ceramic articles of this example (Exs. 4A and 4B), as generated by XRD as a function of time during the growth/crystallization phase of a ceramming cycle at 875° C. Note that each sample was cerammed at the specified temperature and duration, cooled to room temperature, and then evaluated using XRD. FIG. 7B demonstrates the evolution of minor phases during the growth/crystallization step at 875° C. for a glass-ceramic derived from a precursor glass with higher β-OH content (Ex. 4A) vs a glass-ceramic derived from a precursor glass with a lower β-OH content (Ex. 4B, remelt of Ex. 4A). In particular, FIG. 7B shows that less ZrO₂ evolves in Ex. 4B, which has a lower β-OH content as compared to Ex. 4A, during the ceramming cycle.

### Example 5B

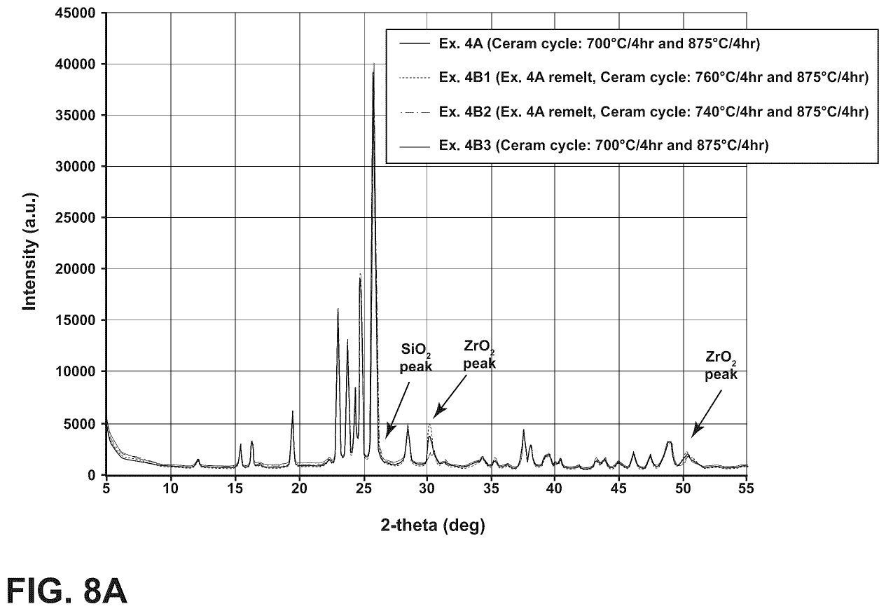

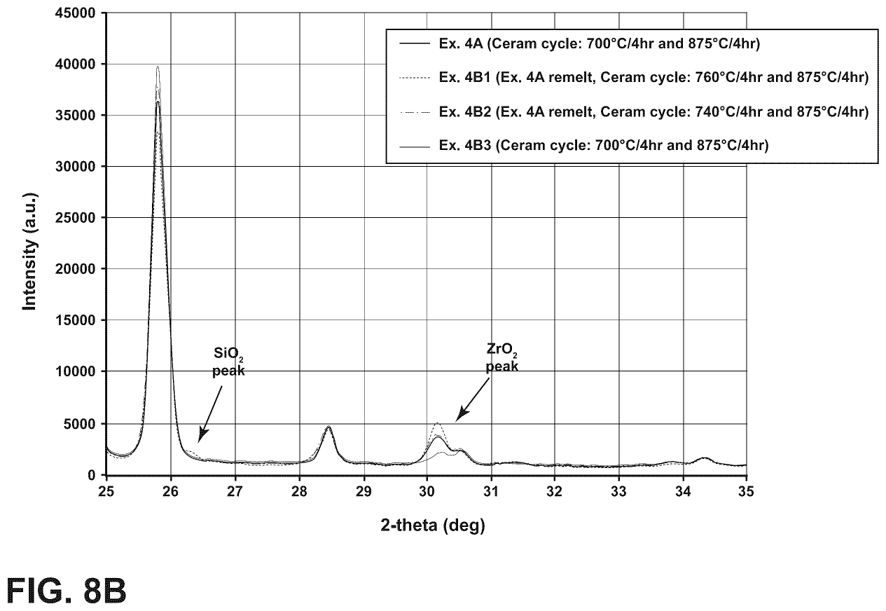

In this example, resulting ZrO₂ levels in glass-ceramic articles are investigated as a function of β-OH content in the precursor glass compositions and ceramming cycle. Referring to FIGS. 8A (20 from 0 to 55) and 8B (20 from 25 to 35), XRD spectra are provided for the Ex. 4B glass-ceramic articles from the prior example, as cerammed with a nucleation at 760° C./4 hr and a crystallization at 875°0 C./4 hr (designated Ex. 4B1); a nucleation at 740° C./4 hr and a crystallization at 875° C./4 hr (designated Ex. 4B2); and a nucleation at 700° C./4 hr and a crystallization at 875° C./4 hr (designated Ex. 4B3). These results are compared to the spectra for the glass-ceramic articles of Ex. 4A from the prior example, as also cerammed with a nucleation at 740° C./4 hr and a crystallization at 875° C./4 hr.

As is evident from FIGS. 8A and 8B, the Ex. 4B3 glass-ceramic article and the Ex. 4A glass-ceramic, as both cerammed at 700° C./4 h+875° C./4 h, but derived from precursor glass compositions with different beta-OH contents, show a clear difference in the amount of ZrO₂ precipitated based on the observed intensity of the ZrO₂ peaks. When increasing the nucleation temperature to 740° C. for the Ex. 4B2 glass-ceramic article, a similar amount of ZrO₂ can be obtained as compared to the Ex. 4A glass-ceramic article. Further, it is evident that increasing the nucleation temperature even further to 760° C. in the Ex. 4B1 glass-ceramic article yields even higher ZrO₂ concentrations.

### Example 6

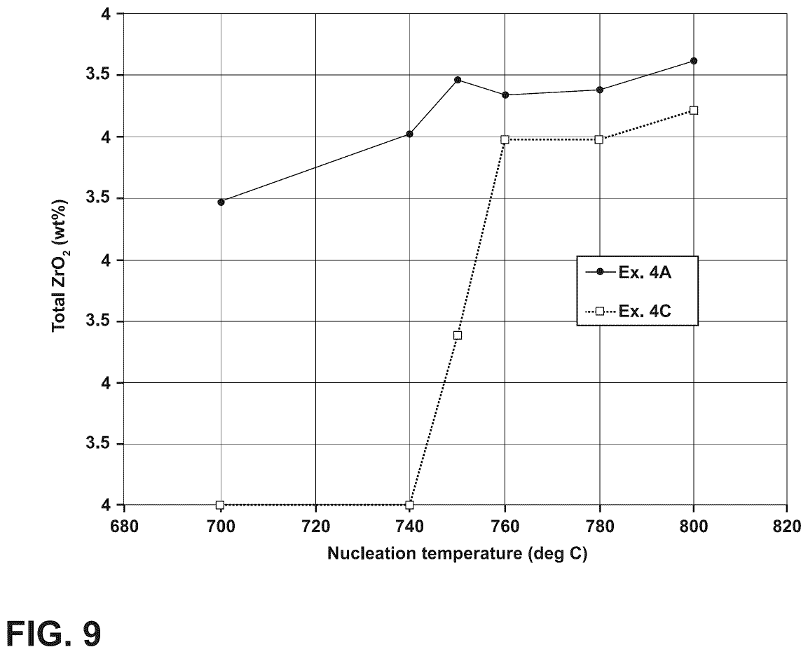

In this example, the total ZrO₂ content is investigated for glass-ceramic articles (Ex. 4A and 4C from the prior examples), as derived from either of two glass precursor compositions with different β-OH content (i.e., Ex. D1 and Ex. D2), as a function of nucleation temperature employed in the ceramming cycle. Referring to FIG. 9, a plot is provided of the amount of ZrO₂ as a function of nucleation temperature for glass-ceramic articles (Ex. 4A and Ex. 4C), as derived from the two glass precursor compositions, Ex. D1 and Ex. D2, according to embodiments of the disclosure. Detailed results are also provided in Table 9 below.

TABLE 9
XRD Rietveld data for glass-ceramic articles derived from the Ex. 4A and
Ex. 4C precursor glass compositions, as cerammed at varying nucleation
temperatures for 4 hours and crystallization at 875° C. for 4 hours

| | Nucleation | | | β- | | Tetragonal | | High | Total |
|---|---|---|---|---|---|---|---|---|---|
| | temp | Glass | Li₂Si₂O₅ | spodumene | Li₃PO₄ | ZrO₂ | Baddeleyite | Quartz | ZrO₂ |
| Sample ID | (° C.) | wt % | wt % | wt % | wt % | wt % | wt % | wt % | wt % |
| Ex. 4A | 700 | — | 42 | 51 | 4.1 | 2 | 0.5 | — | 2.5 |
| Ex. 4A | 740 | — | 43 | 51 | 3.5 | 2 | 1.1 | trace | 3.0 |
| Ex. 4A | 750 | — | 43 | 50 | 3.6 | 2.4 | 1.0 | 0.3 | 1.0 |
| Ex. 4A | 760 | — | 43 | 50 | 3.6 | 2.2 | 1.1 | 0.2 | 3.3 |
| Ex. 4A | 780 | — | 43 | 50 | 3.5 | 2.2 | 1.2 | 0.3 | 3.4 |
| Ex. 4A | 800 | — | 43 | 50 | 3.7 | 2.9 | 0.7 | trace | 3.6 |
| Ex. 4C | 700 | 11 | 37 | 48 | 3.4 | — | — | — | 0.0 |
| Ex. 4C | 740 | 10 | 39 | 48 | 3.6 | — | — | — | 0.0 |
| Ex. 4C | 750 | 3.8 | 42 | 49 | 3.8 | 1.4 | — | — | 1.4 |
| Ex. 4C | 760 | — | 43 | 50 | 3.8 | 2.4 | 0.6 | — | 3.0 |
| Ex. 4C | 780 | — | 43 | 50 | 3.7 | 2.2 | 0.8 | — | 3.0 |
| Ex. 4C | 800 | — | 43 | 50 | 3.6 | 2.5 | 0.7 | 0.2 | 3.2 |

As is evident from Table 9 and FIG. 9, for any given ceram cycle, more total ZrO₂ is obtained from glass-ceramic articles derived from the Ex. D2 precursor glass composition (i.e., Ex. 4A glass-ceramic articles) as compared to the Ex. D1 precursor glass composition with lower β-OH content (i.e., Ex. 4C glass-ceramic articles). For both precursor glass compositions, increased nucleation temperature leads to increased ZrO₂ concentrations in the resulting glass-ceramic articles.

As also evident from Table 9, high quartz is precipitated in the glass-ceramic articles derived from the Ex. D2 precursor glass composition when the nucleation temperature is above 700° C. However, the high quartz phase only appears in the glass-ceramic articles derived from the Ex. D1 precursor glass composition when the nucleation temperature exceeds 780° C. As such, the threshold for high quartz nucleation is shifted by about 80° between the glass-ceramic articles derived from these two precursor glass compositions. In addition, it is evident from Table 9 that the phase assemblages for the glass-ceramic articles derived from the Ex. D1 precursor glass composition with a nucleation at 800° C. are very similar to the assemblages for the glass-ceramic articles derived from the Ex. D2 precursor glass composition with a nucleation at 760° C.

Accordingly, the behavior of these two precursor glass compositions (Ex. D1, lower β-OH content; and Ex. D2, higher β-OH content) with the foregoing ceramming cycles is qualitatively similar. However, this behavior appears shifted and higher nucleation temperatures are required to obtain the same crystallization patterns. Thus, it is evident that ceramming cycles can be tuned to obtain similar glass-ceramic articles when starting with different precursor glass compositions that have varying β-OH levels. For example, precursor glass compositions of this disclosure with lower β-OH content can be subjected to ceramming at higher nucleation temperatures to achieve similar ZrO₂ and opacity as compared to glass-ceramic articles derived from precursor glass compositions with higher β-OH content.

### Example 6A

As is evident from this example, the color and opacity of the white glass-ceramic articles of this disclosure can depend on the crystalline phase assemblage generated as a function of the ceramming cycle. As illustrated in Table 10 below, color and opacity is reported for glass-ceramic articles (0.8 mm thickness) derived from the Ex. D2 precursor glass composition (as designated Ex. 4A), as subjected to the ceramming process noted in the table.

As is also evident from this example, and particularly Table 11 below, controlling the β-OH concentration in the precursor glass facilitates the production of glass-ceramic articles with different color and opacity for a given ceramming cycle. Table 11 provides color coordinates and opacity for glass-ceramic articles (0.8 mm thickness) derived from the Ex. D1 and Ex. D2 precursor glass compositions, designated Ex. 4C and Ex. 4A, respectively. Further, as detailed in Table 11, these glass-ceramic articles were subjected to the same ceramming cycle, except the nucleation temperature was varied from 700° C. to 800° C.

TABLE 10
Color coordinates and opacity measured on glass-ceramic articles (Ex. 4A) derived from
the Ex. D2 precursor glass composition, as subjected to varying ceramming conditions

| | | Hold 1 | Hold 1 | Hold 2 | Hold 2 | wr % | | | | |
|---|---|---|---|---|---|---|---|---|---|---|
| Glass-ceramic/ | β-OH in | Temp. | time | Temp. | time | ZrO₂ in | Color coordinates | | | Opacity |
| precursor glass | glass | (° C.) | (hour) | (° C.) | (hour) | GC | L* | a* | b* | (%) |
| Ex. 4A/Ex. D2 | 0.348 | 700 | 4 | 875 | 4 | 2.5 | 94.72 | −0.79 | −0.63 | 87 |
| Ex. 4A/Ex. D2 | 0.348 | 760 | 4 | 875 | 1 | N/A | 94.42 | −0.66 | −0.32 | 87 |
| Ex. 4A/Ex. D2 | 0.348 | 760 | 4 | 850 | 4 | N/A | 94.45 | −0.56 | −0.62 | 90 |
| Ex. 4A/Ex. D2 | 0.348 | 760 | 4 | 825 | 4 | N/A | 93.38 | −0.53 | 0.04 | 77 |
| Ex. 4A/Ex. D2 | 0.348 | 760 | 4 | 800 | 4 | N/A | 92.37 | −0.81 | 0.98 | 65 |
| Ex. 4A/Ex. D2 | 0.348 | 650 | 4 | 865 | 4 | 2.5 | 93.77 | −0.65 | −0.3 | 87 |
| Ex. 4A/Ex. D2 | 0.348 | 700 | 4 | 865 | 4 | 3 | 94.5 | −0.67 | −0.33 | 91 |
| Ex. 4A/Ex. D2 | 0.348 | 720 | 4 | 865 | 4 | 3.2 | 94.84 | −0.67 | −0.37 | 93 |
| Ex. 4A/Ex. D2 | 0.348 | 740 | 4 | 865 | 4 | 3.44 | 95.41 | −0.64 | −0.24 | 96 |
| Ex. 4A/Ex. D2 | 0.348 | 750 | 4 | 865 | 4 | 3.6 | 95.21 | −0.62 | −0.34 | 95 |
| Ex. 4A/Ex. D2 | 0.348 | 760 | 4 | 865 | 4 | 3.4 | 95.33 | −0.52 | −0.48 | 95 |
| Ex. 4A/Ex. D2 | 0.348 | 750 | 4 | 875 | 4 | 3.42 | 95.87 | −0.64 | −0.04 | 97 |
| Ex. 4A/Ex. D2 | 0.348 | 750 | 4 | 885 | 1 | 3.17 | 95.65 | −0.68 | −0.28 | 96 |
| Ex. 4A/Ex. D2 | 0.348 | 750 | 4 | 885 | 4 | 3.41 | 96.29 | −0.6 | 0.33 | 98 |
| Ex. 4A/Ex. D2 | 0.348 | 700 | 4 | 875 | 4 | 2.73 | 95.06 | −0.73 | −0.42 | 93 |
| Ex. 4A/Ex. D2 | 0.348 | 700 | 4 | 855 | 4 | 3.55 | 94.45 | −0.59 | −0.25 | 91 |
| Ex. 4A/Ex. D2 | 0.348 | 720 | 4 | 875 | 4 | 2.63 | 94.97 | −0.76 | −0.38 | 94 |

TABLE 11
Color coordinates and opacity measured on glass-ceramic articles (Ex. 4A and Ex. 4C) derived from the Ex.
D2 and Ex. D1 precursor glass compositions, respectively, as subjected to varying ceramming conditions

| | | Hold 1 | Hold 1 | Hold 2 | Hold 2 | wt % | | | | |
|---|---|---|---|---|---|---|---|---|---|---|
| Glass-ceramic/ | β-OH | Temp. | time | Temp. | time | ZrO₂ | Color coordinates | | | Opacity |
| precursor glass | in glass | (° C.) | (hour) | (° C.) | (hour) | in GC | L* | a* | b* | (%) |
| Ex. 4A (from Ex. D2) | 0.348 | 700 | 4 | 875 | 4 | 2.5 | 94.72 | −0.79 | −0.63 | 87 |
| Ex. 4C (from Ex. D1) | 0.182 | 700 | 4 | 875 | 4 | 0 | 94.04 | −0.82 | −0.44 | 66 |
| Ex. 4A (from Ex. D2) | 0.348 | 740 | 4 | 875 | 4 | 3 | n/a | n/a | n/a | n/a |
| Ex. 4C (from Ex. D1) | 0.182 | 740 | 4 | 875 | 4 | 0 | 94.29 | −0.77 | −0.59 | 67 |
| Ex. 4A (from Ex. D2) | 0.348 | 750 | 4 | 875 | 4 | 3.4 | 95.87 | −0.59 | 0.07 | 96 |
| Ex. 4C (from Ex. D1) | 0.182 | 750 | 4 | 875 | 4 | 1.4 | 95.17 | −0.62 | −0.87 | 88 |
| Ex. 4A (from Ex. D2) | 0.348 | 760 | 4 | 875 | 1 | 3.3 | 94.42 | −0.66 | −0.32 | 87 |
| Ex. 4C (from Ex. D1) | 0.182 | 760 | 4 | 875 | 4 | 3.3 | 95.37 | −0.58 | −1.02 | 87 |
| Ex. 4A (from Ex. D2) | 0.348 | 780 | 4 | 875 | 4 | 3.4 | 95.89 | −0.6 | 0.06 | 96 |
| Ex. 4C (from Ex. D1) | 0.182 | 780 | 4 | 875 | 4 | 3 | 95.77 | −0.61 | −0.81 | 92 |
| Ex. 4A (from Ex. D2) | 0.348 | 800 | 4 | 875 | 4 | 3.6 | 94.84 | −0.65 | −0.47 | 93 |
| Ex. 4C (from Ex. D1) | 0.182 | 800 | 4 | 875 | 4 | 3.2 | 95.78 | −0.63 | −0.93 | 92 |

The various features described in the specification may be combined in any and all combinations. for example. as listed in the following embodiments.

Aspect 1. A glass-ceramic article is provided that includes (in mol %):
68-70% SiO₂;
3.5-4.5% Al₂O₃;
0.5-1.5% P₂O₅;
20-24% Li₂O;
0-0.5% Na₂O;
0-0.5% K₂O;
2.5-3.1% ZrO₂;
0.5-1.0% CaO;
0-0.2% Fe₂O₃;
0-0.2% HfO₂; and
0.001-0.2% SnO₂. The glass-ceramic article is opaque, and further comprises a lithium disilicate crystalline phase, a β-spodumene solid solution crystalline phase, a Zr-based crystalline phase, and a lithium phosphate crystalline phase.

Aspect 2. The glass-ceramic article of Aspect 1 is provided, wherein the glass-ceramic article further comprises an opacity from about 75 to 95%, as measured through the glass-ceramic article with a thickness of about 0.5 mm.

Aspect 3. The glass-ceramic article of Aspect 1 or Aspect 2 is provided, wherein the glass-ceramic article further comprises a reflected color given by L* from 80 to 98, a* from −2.0 to 0, and b* from −10.0 to 0 (CIE L*, a* and b* coordinate system).

Aspect 4. The glass-ceramic article of any one of Aspects 1-3 is provided, wherein the glass-ceramic article further comprises a fracture toughness (K_{IC}) of from 1.0 to 3.0 MPa*m^{1/2}, as measured by the Chevron Notch Short Bar Method.

Aspect 5. The glass-ceramic article of any one of Aspects 1-3 is provided, wherein the glass-ceramic article further comprises a fracture toughness (K_{IC}) of from 1.5 to 3.0 MPa*m^{1/2}, as measured by the Chevron Notch Short Bar Method.

Aspect 6. The glass-ceramic article of any one of Aspects 1-5 is provided, wherein the lithium disilicate crystalline phase comprises needles having a length from 0.5 to 2 μm and a width from 100 to 500 nm, the β-spodumene crystalline phase comprises crystals from 0.5 to 2 μm in size, the Zr-based crystalline phase comprises crystals from 50 to 500 nm in size, and the lithium phosphate crystalline phase comprises crystals from 50 to 500 nm in size.

Aspect 7. The glass-ceramic article of any one of Aspects 1-6 is provided, further comprising a compressive stress region comprising at least 0.1 mol % K₂O at a depth of 10 μm or less from a primary surface of the glass-ceramic article, and a depth of layer (DOL) of less than or equal to 0.24*t, wherein t is a thickness of the glass-ceramic article.

Aspect 8. The glass-ceramic article of any one of Aspects 1-7 is provided, wherein the glass-ceramic article further comprises a Knoop hardness of greater than 500 kgf/mm² and an elastic modulus of greater than 95 GPa.

Aspect 9. a glass-ceramic article is provided that includes (in mol %):
70-72% SiO₂;
3.5-4.5% Al₂O₃;
0.5-1.5% P₂O₅;
20-24% Li₂O;
0-0.5% Na₂O;
0-0.5% K₂O;
1.7-2.3% ZrO₂;
0-0.5% CaO;
0-0.2% Fe₂O₃;
0-0.2% HfO₂; and
0.001-0.2% SnO₂. The glass-ceramic article is opaque, and comprises a β-spodumene solid solution crystalline phase, a lithium disilicate crystalline phase, and one or more ZrO₂-containing crystalline phases. Further, the glass-ceramic article is derived from a glass precursor having a β-OH content from 0.1 to 0.5/mm.

Aspect 10. The glass-ceramic article of Aspect 9, or any preceding Aspect, is provided, wherein the glass-ceramic article is derived from a glass precursor having a β-OH content from 0.15/mm to 0.4/mm.

Aspect 11. The glass-ceramic article of Aspect 9 or Aspect 10, or any preceding Aspect, is provided, wherein the glass-ceramic article further comprises an opacity from about 60 to 97%, as measured through the glass-ceramic article with a thickness of about 0.5 mm.

Aspect 12. The glass-ceramic article of any one of Aspects 9-11, or any preceding Aspect, is provided, wherein the glass-ceramic article further comprises a reflected color given by L* from 85 to 98, a* from −3.0 to +3.0, and b* from −5.0 to +5.0 (CIE L*, a* and b* coordinate system).

Aspect 13. The glass-ceramic article of any one of Aspects 9-12, or any preceding Aspect, is provided, wherein the glass-ceramic article further comprises a fracture toughness (K_{IC}) of from 1.0 to 3.0 MPa*m^{1/2}, as measured by the Chevron Notch Short Bar Method.

Aspect 14. The glass-ceramic article of any one of Aspects 9-13, or any preceding Aspect, is provided, wherein the one or more ZrO₂-containing crystalline phases total from 0.5 to 4.0% by weight in the glass-ceramic article, as determined by Rietveld analysis of x-ray diffraction (XRD) data from the glass-ceramic article.

Aspect 15. The glass-ceramic article of any one of Aspects 9-14, or any preceding Aspect, is provided, further comprising a compressive stress region comprising at least 0.1 mol % K₂O at a depth of 10 μm or less from a primary surface of the glass-ceramic article, and a depth of layer (DOL) of less than or equal to 0.24*t, wherein t is a thickness of the glass-ceramic article.

Aspect 16. The glass-ceramic article of any one of Aspects 9-15, or any preceding Aspect, is provided, wherein the glass-ceramic article further comprises a Knoop hardness of greater than 500 kgf/mm² and an elastic modulus of greater than 95 GPa.

Aspect 17. A glass-ceramic article is provided that includes (in mol %):
67-74% SiO₂;
2-6% Al₂O₃;
0.5-1.5% P₂O₅;
18-25% Li₂O;
0-1% Na₂O;
0-1% K₂O;
1-4% ZrO₂;
0-2% CaO; and
0.001-0.5% SnO₂. The glass-ceramic article is opaque, and further comprises a lithium disilicate crystalline phase, a β-spodumene solid solution crystalline phase, a Zr-based crystalline phase, and a lithium phosphate crystalline phase.

Aspect 18. The glass-ceramic article of Aspect 17, or any preceding Aspect, is provided, wherein the glass-ceramic article further comprises a fracture toughness (K_{IC}) of from 1.0 to 3.0 MPa*m^{1/2}, as measured by the Chevron Notch Short Bar Method, and an opacity from about 60 to 97%, as measured through the glass-ceramic article with a thickness of about 0.5 mm.

Aspect 19. The glass-ceramic article of Aspect 17 or Aspect 18, or any preceding Aspect, is provided, wherein the glass-ceramic article further comprises a reflected color given by L* from 80 to 98, a* from −3.0 to +3.0, and b* from −10.0 to +5.0 (CIE L*, a* and b* coordinate system).

Aspect 20. The glass-ceramic article of any one of Aspects 17-19, or any preceding Aspect, is provided, wherein the glass-ceramic article comprises a β-spodumene solid solution crystalline phase, a lithium disilicate crystalline phase, and one or more ZrO₂-containing crystalline phases.

Aspect 21. The glass-ceramic article of any one of Aspects 17-20, or any preceding Aspect, is provided, wherein the glass-ceramic article is derived from a glass precursor having a β-OH content from 0.1/mm to 0.5/mm.

Aspect 22. The glass-ceramic article of any one of Aspects 17-21, or any preceding Aspect, is provided, further comprising a compressive stress region comprising at least 0.1 mol % K₂O at a depth of 10 μm or less from a primary surface of the glass-ceramic article, and a depth of layer (DOL) of less than or equal to 0.24*t, wherein t is a thickness of the glass-ceramic article.

Aspect 23. The glass-ceramic article of any one of Aspects 17-22, or any preceding Aspect, is provided, wherein the glass-ceramic article further comprises a Knoop hardness of greater than 500 kgf/mm² and an elastic modulus of greater than 95 GPa.

Aspect 24. A glass-ceramic article, comprising (in mol %):
67-74% SiO₂;
2-6% Al₂O₃;
0.5-1.5% P₂O₅;
18-25% Li₂O;
0-1% Na₂O;
0-1% K₂O;
1-4% ZrO₂;
0-2% CaO; and
0.001-0.5% SnO₂,
wherein the glass-ceramic article is opaque, and
further wherein the glass-ceramic article comprises a lithium disilicate crystalline phase, a β-spodumene solid solution crystalline phase, a Zr-based crystalline phase, and a lithium phosphate crystalline phase.

Aspect 25. The glass-ceramic article of Aspect 24, or any preceding Aspect, wherein the glass-ceramic article further comprises a fracture toughness (K_{IC}) of from 1.0 to 3.0 MPa*m^{1/2}, as measured by the Chevron Notch Short Bar Method, and further wherein the glass-ceramic article comprises an opacity from 60 to 97%, as measured through the glass-ceramic article with a thickness of 0.5 mm.

Aspect 26. The glass-ceramic article of Aspect 24 or Aspect 25, or any preceding Aspect, wherein the glass-ceramic article further comprises a reflected color given by L* from 80 to 98, a* from −3.0 to +3.0, and b* from −10.0 to +5.0 (CIE L*, a* and b* coordinate system).

Aspect 27. The glass-ceramic article of any one of Aspects 24-26, or any preceding Aspect, wherein the glass-ceramic article comprises a β-spodumene solid solution crystalline phase, a lithium disilicate crystalline phase, and one or more ZrO₂-containing crystalline phases.

Aspect 28. The glass-ceramic article of any one of Aspects 24-27, or any preceding Aspect, wherein the glass-ceramic article is derived from a glass precursor having a β-OH content from 0.1/mm to 0.5/mm.

Aspect 29. The glass-ceramic article of any one of Aspects 24-28, or any preceding Aspect, further comprising:
a compressive stress region comprising at least 0.1 mol % K₂O at a depth of 10 μm or less from a primary surface of the glass-ceramic article; and
a depth of layer (DOL) of less than or equal to 0.24*t, wherein t is a thickness of the glass-ceramic article.

Aspect 30. The glass-ceramic article of any one of Aspects 24-29, or any preceding Aspect, wherein the glass-ceramic article further comprises a Knoop hardness of greater than 500 kgf/mm² and an elastic modulus of greater than 95 GPa.

Aspect 31. The glass-ceramic article of any one of Aspects 24-30, or any preceding Aspect, wherein the glass-ceramic article further comprises (in mol %):
70-72% SiO₂;
3.5-4.5% Al₂O₃;
0.5-1.5% P₂O₅;
20-24% Li₂O;
0-0.5% Na₂O;
0-0.5% K₂O;
1.7-2.3% ZrO₂;
0-0.5% CaO;
0-0.2% Fe₂O₃;
0-0.2% HfO₂; and
0.001-0.2% SnO₂.

Aspect 32. The glass-ceramic article of Aspect 31, or any preceding Aspect, wherein the glass-ceramic article is derived from a glass precursor having a β-OH content from 0.15/mm to 0.4/mm.

Aspect 33. The glass-ceramic article of Aspect 31 or Aspect 32, or any preceding Aspect, wherein the glass-ceramic article further comprises an opacity from 60 to 97%, as measured through the glass-ceramic article with a thickness of 0.5 mm.

Aspect 34. The glass-ceramic article of any one of Aspects 31-33, or any preceding Aspect, wherein the glass-ceramic article further comprises a reflected color given by L* from 85 to 98, a* from −3.0 to +3.0, and b* from −5.0 to +5.0 (CIE L*, a* and b* coordinate system).

Aspect 35. The glass-ceramic article of any one of Aspect 24-30, or any preceding Aspect, wherein the glass-ceramic article further comprises (in mol %):
68-70% SiO₂;
3.5-4.5% Al₂O₃;
0.5-1.5% P₂O₅;
20-24% Li₂O;
0-0.5% Na₂O;
0-0.5% K₂O;
2.5-3.1% ZrO₂;
0.5-1.0% CaO;
0-0.2% Fe₂O₃;
0-0.2% HfO₂; and
0.001-0.2% SnO₂.

Aspect 36. The glass-ceramic article of Aspect 35, or any preceding Aspect, wherein the glass-ceramic article further comprises an opacity from 75 to 95%, as measured through the glass-ceramic article with a thickness of 0.5 mm.

Aspect 37. The glass-ceramic article of Aspect 35 or Aspect 36, or any preceding Aspect, wherein the glass-ceramic article further comprises a reflected color given by L* from 80 to 98, a* from −2.0 to 0, and b* from −10.0 to 0 (CIE L*, a* and b* coordinate system).

Aspect 38. The glass-ceramic article of any one of Aspects 35-37, or any preceding Aspect, wherein the glass-ceramic article further comprises a fracture toughness (K_{IC}) of from 1.5 to 3.0 MPa*m^{1/2}, as measured by the Chevron Notch Short Bar Method.

Aspect 39. A glass-ceramic article, comprising (in mol %):
67-74% SiO₂;
2-6% Al₂O₃;
0.5-1.5% P₂O₅;
18-25% Li₂O;
0-1% Na₂O;
0-1% K₂O;
1-4% ZrO₂;
0-2% CaO; and
0.001-0.5% SnO₂,
wherein the glass-ceramic article is opaque, and
further wherein the glass-ceramic article comprises a lithium disilicate crystalline phase, a β-spodumene solid solution crystalline phase, a Zr-based crystalline phase, and a lithium phosphate crystalline phase.

Aspect 40. The glass-ceramic article of Aspect 39, or any preceding Aspect, wherein the glass-ceramic article further comprises a fracture toughness (K_{IC}) of from 1.0 to 3.0 MPa*m^{1/2}, as measured by the Chevron Notch Short Bar Method, and further wherein the glass-ceramic article comprises an opacity from 60 to 97%, as measured through the glass-ceramic article with a thickness of 0.5 mm.

Aspect 41. The glass-ceramic article of Aspect 39 or Aspect 40, or any preceding Aspect, wherein the glass-ceramic article further comprises a reflected color given by L* from 80 to 98, a* from −3.0 to +3.0, and b* from −10.0 to +5.0 (CIE L*, a* and b* coordinate system).

Aspect 42. The glass-ceramic article of any one of Aspects 39-41, or any preceding Aspect, wherein the glass-ceramic article comprises a β-spodumene solid solution crystalline phase, a lithium disilicate crystalline phase, and one or more ZrO₂-containing crystalline phases.

Aspect 43. The glass-ceramic article of any one of Aspects 39-42, or any preceding Aspect, wherein the glass-ceramic article is derived from a glass precursor having a β-OH content from 0.1/mm to 0.5/mm.

Aspect 44. The glass-ceramic article of any one of Aspects 39-43, or any preceding Aspect, further comprising:
a compressive stress region comprising at least 0.1 mol % K₂O at a depth of 10 μm or less from a primary surface of the glass-ceramic article: and
a depth of layer (DOL) of less than or equal to 0.24*t, wherein t is a thickness of the glass-ceramic article.

Aspect 45. The glass-ceramic article of any one of Aspects 39-44, or any preceding Aspect, wherein the glass-ceramic article further comprises (in mol %):
70-72% SiO₂;
3.5-4.5% Al₂O₃;
0.5-1.5% P₂O₅;
20-24% Li₂O;
0-0.5% Na₂O;
0-0.5% K₂O;
1.7-2.3% ZrO₂;
0-0.5% CaO;
0-0.2% Fe₂O₃;
0-0.2% HfO₂; and
0.001-0.2% SnO₂.

Aspect 46. The glass-ceramic article of Aspect 45, or any preceding Aspect, wherein the glass-ceramic article is derived from a glass precursor having a β-OH content from 0.15/mm to 0.4/mm.

Aspect 47. The glass-ceramic article of any one of Aspects 39-43, or any preceding Aspect, wherein the glass-ceramic article further comprises (in mol %):
68-70% SiO₂;
3.5-4.5% Al₂O₃;
0.5-1.5% P₂O₅;
20-24% Li₂O;
0-0.5% Na₂O;
0-0.5% K₂O;
2.5-3.1% ZrO₂;
0.5-1.0% CaO;
0-0.2% Fe₂O₃;
0-0.2% HfO₂; and
0.001-0.2% SnO₂.

Aspect 48. The glass-ceramic article of Aspect 47, or any preceding Aspect, wherein the glass-ceramic article further comprises an opacity from 75 to 95%, as measured through the glass-ceramic article with a thickness of 0.5 mm.

What is claimed is:

1. A glass-ceramic article, comprising (in mol %):
68-70% SiO₂;
3.5-4.5% Al₂O₃;
0.5-1.5% P₂O₅;
20-24% Li₂O;
0-0.5% Na₂O;
0-0.5% K₂O;
2.5-3.1% ZrO₂;
0.5-1.0% CaO;
0-0.2% Fe₂O₃;
0-0.2% HfO₂; and
0.001-0.2% SnO₂,
wherein the glass-ceramic article is opaque, and
further wherein the glass-ceramic article comprises a lithium disilicate crystalline phase, a β-spodumene solid solution crystalline phase, a Zr-based crystalline phase, and a lithium phosphate crystalline phase.

2. The glass-ceramic article of claim 1, wherein the glass-ceramic article further comprises an opacity from 75 to 95%, as measured through the glass-ceramic article with a thickness of 0.5 mm.

3. The glass-ceramic article of claim 1, wherein the glass-ceramic article further comprises a reflected color given by L* from 80 to 98, a* from −2.0 to 0, and b* from −10.0 to 0 (CIE L*, a* and b* coordinate system).

4. The glass-ceramic article of claim 1, wherein the glass-ceramic article further comprises at least one of:
a fracture toughness (K_{IC}) of from 1.0 to 3.0 MPa*m^{1/2}, as measured by the Chevron Notch Short Bar Method; and
a Knoop hardness of greater than 500 kgf/mm² and an elastic modulus of greater than 95 GPa.

5. The glass-ceramic article of claim 1, wherein the lithium disilicate crystalline phase comprises needles having a length from 0.5 to 2 μm and a width from 100 to 500 nm, the β-spodumene crystalline phase comprises crystals from 0.5 to 2 μm in size, the Zr-based crystalline phase comprises crystals from 50 to 500 nm in size, and the lithium phosphate crystalline phase comprises crystals from 50 to 500 nm in size.

6. The glass-ceramic article of claim 1, further comprising:
a compressive stress region comprising at least 0.1 mol % K₂O at a depth of 10 μm or less from a primary surface of the glass-ceramic article; and
a depth of layer (DOL) of less than or equal to 0.24*t, wherein t is a thickness of the glass-ceramic article.

7. A glass-ceramic article, comprising (in mol %):
70-72% SiO₂;
3.5-4.5% Al₂O₃;
0.5-1.5% P₂O₅;
20-24% Li₂O;
0-0.5% Na₂O;
0-0.5% K₂O;
1.7-2.3% ZrO₂;
0-0.5% CaO;
0-0.2% Fe₂O₃;
0-0.2% HfO₂; and
0.001-0.2% SnO₂,
wherein the glass-ceramic article is opaque,
wherein the glass-ceramic article comprises a β-spodumene solid solution crystalline phase, a lithium disilicate crystalline phase, and one or more ZrO₂-containing crystalline phases, and
further wherein the glass-ceramic article is derived from a glass precursor having a β-OH content from 0.1/mm to 0.5/mm.

8. The glass-ceramic article of claim 7, wherein the glass-ceramic article is derived from a glass precursor having a β-OH content from 0.15/mm to 0.4/mm.

9. The glass-ceramic article of claim 7, wherein the glass-ceramic article further comprises an opacity from 60 to 97%, as measured through the glass-ceramic article with a thickness of 0.5 mm.

10. The glass-ceramic article of claim 7, wherein the glass-ceramic article further comprises a reflected color given by L* from 85 to 98, a* from −3.0 to +3.0, and b* from −5.0 to +5.0 (CIE L*, a* and b* coordinate system).

11. The glass-ceramic article of claim 7, wherein the glass-ceramic article further comprises at least one of:
a fracture toughness (K_{IC}) of from 1.0 to 3.0 MPa*m^{1/2}, as measured by the Chevron Notch Short Bar Method; and
a Knoop hardness of greater than 500 kgf/mm² and an elastic modulus of greater than 95 GPa.

12. The glass-ceramic article of claim 7, wherein the one or more ZrO₂-containing crystalline phases total from 0.5 to 4.0% by weight in the glass-ceramic article, as determined by Rietveld analysis of x-ray diffraction (XRD) data from the glass-ceramic article.

13. The glass-ceramic article of claim 7, further comprising:
a compressive stress region comprising at least 0.1 mol % K₂O at a depth of 10 μm or less from a primary surface of the glass-ceramic article; and
a depth of layer (DOL) of less than or equal to 0.24*t, wherein t is a thickness of the glass-ceramic article.

14. A glass-ceramic article, comprising (in mol %):
67-74% SiO₂;
2-6% Al₂O₃;
0.5-1.5% P₂O₅;
18-25% Li₂O;
0-1% Na₂O;
0-1% K₂O;
1-4% ZrO₂;
0-2% CaO; and
0.001-0.5% SnO₂,
wherein the glass-ceramic article is opaque, and
further wherein the glass-ceramic article comprises a lithium disilicate crystalline phase, a β-spodumene solid solution crystalline phase, a Zr-based crystalline phase, and a lithium phosphate crystalline phase.

15. The glass-ceramic article of claim 14, wherein the glass-ceramic article further comprises a fracture toughness (K_{IC}) of from 1.0 to 3.0 MPa*m^{1/2}, as measured by the Chevron Notch Short Bar Method, and further wherein the glass-ceramic article comprises an opacity from 60 to 97%, as measured through the glass-ceramic article with a thickness of 0.5 mm.

16. The glass-ceramic article of claim 14, wherein the glass-ceramic article further comprises a reflected color given by L* from 80 to 98, a* from −3.0 to +3.0, and b* from −10.0 to +5.0 (CIE L*, a* and b* coordinate system).

17. The glass-ceramic article of claim 14, wherein the glass-ceramic article comprises a β-spodumene solid solution crystalline phase, a lithium disilicate crystalline phase, and one or more ZrO₂-containing crystalline phases.

18. The glass-ceramic article of claim 14, wherein the glass-ceramic article is derived from a glass precursor having a β-OH content from 0.1/mm to 0.5/mm.

19. The glass-ceramic article of claim 14, further comprising:
a compressive stress region comprising at least 0.1 mol % K₂O at a depth of 10 μm or less from a primary surface of the glass-ceramic article; and
a depth of layer (DOL) of less than or equal to 0.24*t, wherein t is a thickness of the glass-ceramic article.

20. The glass-ceramic article of claim 14, wherein the glass-ceramic article further comprises a Knoop hardness of greater than 500 kgf/mm² and an elastic modulus of greater than 95 GPa.
